(19) United States
(12) Patent Application Publication
(10) Pub. No.: US 2026/0369291 A1
(43) Pub. Date: Nov. 19, 2026

(54) ADAPTIVE NOISE CANCELLATION FOR PERFORMANCE TRANSLATIONS BY ELECTRONIC DEVICES

(71) Applicant: Apple Inc., Cupertino, CA (US)

(72) Inventors: Yang LU, San Jose, CA (US); Ashok MASILAMANI, San Diego, CA (US); Hanchi CHEN, Cupertino, CA (US); Mitchell R. LERNER, San Francisco, CA (US); Vladan BAJIC, San Francisco, CA (US)

(21) Appl. No.: 19/656,846

(22) Filed: Apr. 23, 2026

Related U.S. Application Data
(63) Continuation of application No. 19/641,428, filed on Apr. 7, 2026.
(60) Provisional application No. 63/806,599, filed on May 15, 2025.

(51) Int. Cl. G10L 21/0232; G10K 11/178

(52) U.S. Cl. CPC G10L 21/0232; G10K 11/17854

(57) ABSTRACT

Aspects of the subject technology relate to temporarily increasing noise cancellation when a computer-generated translated voice is being output by one or more speakers of an electronic device. The increase in the noise cancellation may be a frequency-dependent increase. The frequency-dependent increase effectively blur the ambient noise that reaches the ears of the user, while enhancing the ability of the user to hear and understand the computer-generated translated voice.

### CROSS REFERENCE TO RELATED APPLICATIONS

This application is a continuation of U.S. Patent Application No. 19/641,428, entitled “Adaptive Noise Cancellation for Real-Time Audio Translations by Electronic Devices”, filed on Apr. 7, 2026, which claims the benefit of priority to U.S. Provisional Patent Application No. 63/806,599, entitled, “Adaptive Noise Cancellation for Real-Time Audio Translations by Electronic Devices”, filed on May 15, 2025, the disclosure of which is hereby incorporated herein in its entirety.

### TECHNICAL FIELD

The present description relates generally to audio devices and, more particularly, for example, to adaptive noise cancellation for real-time audio translations by electronic devices.

### BACKGROUND

Earbuds and headphones are often used for noise cancellation, in which the earbuds or headphones sense sounds in the ambient environment and attempt to output an anti-noise sound that cancels some of the sounds in the ambient environment.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 is a schematic diagram illustrating a use case in which noise cancellation is performed during a translation operation in accordance with implementations of the subject technology.

FIG. 3 is a schematic diagram illustrating a use case in which noise cancellation is performed during a translation operation involving multiple devices in accordance with implementations of the subject technology.

FIG. 4 is a timing diagram illustrating modifications to a noise cancellation operation that may be performed during a translation operation in accordance with one or more implementations of the subject technology.

FIG. 5 illustrates a block diagram of a first example audio signal processing architecture for an electronic device in accordance with one or more implementations.

FIG. 6 illustrates a block diagram of a second example audio signal processing architecture for an electronic device in accordance with one or more implementations.

FIG. 7 illustrates various noise cancellation attenuation curves in accordance with one or more implementations.

FIG. 8 illustrates a block diagram of a third audio signal processing architecture for an electronic device in accordance with one or more implementations.

FIG. 9 illustrates additional details that may be implemented in the audio signal processing architecture of FIG. 8 in accordance with one or more implementations.

FIG. 10 illustrates various examples of mixing curves in accordance with one or more implementations.

FIG. 11 illustrates examples of modified mixing values that are offset from a mixing curve in accordance with one or more implementations.

FIG. 12 illustrates a block diagram of a fourth audio signal processing architecture for an electronic device in accordance with one or more implementations.

FIG. 13 illustrates examples of gain curves in accordance with one or more implementations.

FIG. 14 illustrates additional details that may be implemented in the audio signal processing architecture of FIG. 12 in accordance with one or more implementations.

FIG. 15 illustrates additional details that may be implemented in the audio signal processing architecture of FIG. 14 in accordance with one or more implementations.

FIG. 16 is a flow diagram for an example process for adaptive noise cancellation for real-time audio translations by electronic devices in accordance with one or more implementations of the subject technology.

FIG. 17 illustrates a block diagram of a fifth audio signal processing architecture for an electronic device in accordance with one or more implementations.

FIG. 18 illustrates additional details that may be implemented in the audio signal processing architecture of FIG. 17 in accordance with one or more implementations.

FIG. 19 is a flow diagram for another example process for adaptive noise cancellation for real-time audio translations by electronic devices in accordance with one or more implementations of the subject technology.

FIG. 20 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Implementations of the subject technology described herein provide for modifications to noise cancellation operations when an electronic device is operating in a translation mode. In a translation mode, an electronic device may capture, using one or more microphones, a voice of a person speaking in a first language in the physical environment of the electronic device, and output, using one or more speakers, a computer-generated audio translation, in a second language, of the voice of the person speaking.

During an untranslated conversation between a user of the electronic device and another person (e.g., both speaking the same language) while the user is wearing an electronic device (e.g., earbuds or headphones), it may make sense to reduce or turn off noise cancellation by the electronic device to allow the voice of the other person to reach the ears of the user. However, in a translation mode in which the voice of the person is being converted into a computer-generated translated voice for output by a speaker of the device that is providing the noise cancellation, reducing noise cancellation (e.g., and thereby increasing the environmental noise that reaches the ears of the user) may reduce the user’s ability to hear the computer-generated translated voice.

Aspects of the subject technology relate to temporarily increasing the amount of noise cancellation when a computer-generated translated voice is being output by the speaker(s) of an electronic device. The increase in the amount of noise cancellation may be a frequency dependent increase (e.g., to effectively blur the environmental noise that reaches the ears of the user, while enhancing the ability of the user to hear and understand the computer-generated translated voice). The frequency-dependent increase may be performed so as to pass through low frequency sound while attenuating mid and/or high frequency sound, and may help to reduce the user’s sensation of pressure changes in their ear as the amount of noise cancellation changes. In some implementations, a reduced or blurred version of the original untranslated voice, and/or an enhanced version of a user’s own voice can also be output by the speaker(s) during the translation session.

The subject technology also addresses another translation scenario in which the voice to be translated is part of a performance, such as an opera, a play, a concert, or a movie, that includes background audio content that is part of the performance experience. In such use cases, increasing background noise cancellation and/or blurring the background sounds while providing the computer-generated translated voice may negatively affect the user’s ability to fully experience the performance. Accordingly, aspects of the subject technology can provide noise cancellation for translated performances, in which the background sounds are passed through, the voice to be translated is removed or reduced, and the computer-generated translated voice is added to the output.

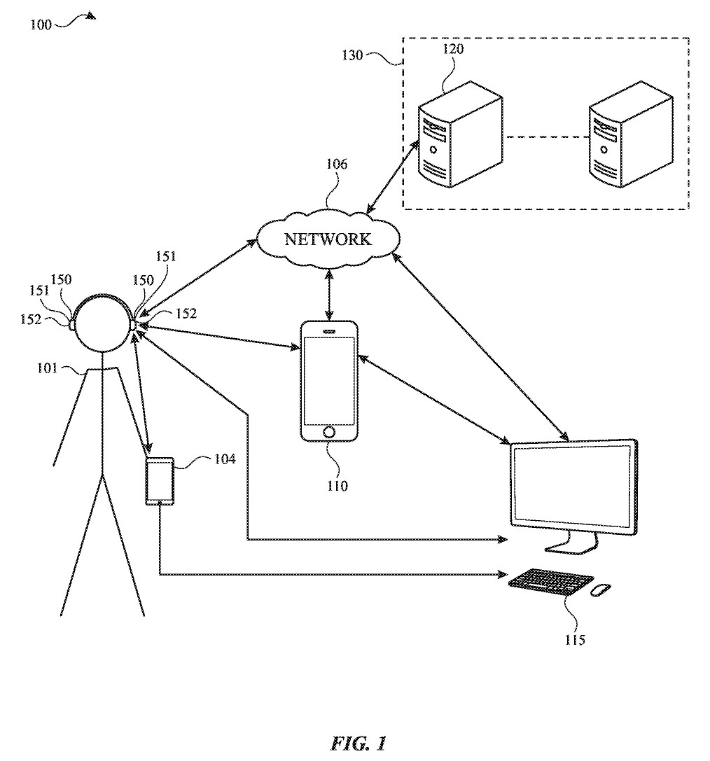

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an audio device 150, an electronic device 104 (e.g., a handheld electronic device such as a smartphone or a tablet), an electronic device 110, an electronic device 115, and a server 120 communicatively coupled by a network 106 (e.g., a local or wide area network). For explanatory purposes, the system architecture 100 is illustrated in FIG. 1 as including the audio device 150, the electronic device 104, the electronic device 110, the electronic device 115, and the server 120; however, the system architecture 100 may include any number of electronic and/or audio devices and any number of servers or a data center including multiple servers.

The audio device 150 may be implemented as headphones (e.g., a pair of speakers mounted in speaker housings that are coupled together by a headband) or an earbud (e.g., an earbud of a pair of earbuds each having a speaker disposed in a housing that conforms to a portion of the user’s ear) configured to be worn by a user (also referred to as a wearer when the audio device is worn by the user). Each audio device 150 may include one or more speakers, such as a speaker 152 configured to project sound into an ear of the user 101, and one or more sensors such as a sensor 151. Sensor 151 may include one or more microphones configured to receive audio inputs (e.g., based on a user’s own voice, environmental sounds, and/or other external voice inputs). Sensor 151 may include other sensors, such as inertial measurement unit (IMU) sensors (e.g., accelerometers, magnetometers, and/or gyroscopes). In one or more implementations, the audio device 150 may be integrated with and/or communicatively coupled with (e.g., and co-operable) with another device, such as a head mountable device (HMD) that includes one or more displays for displaying visual content (e.g. a movie, a show, other video content and/or gaming content) that corresponds to audio content being output by the audio device 150.

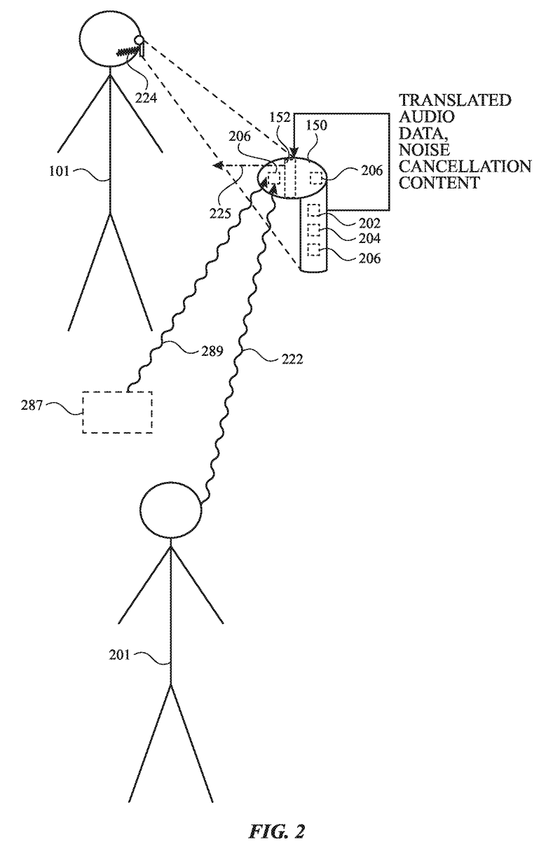

Although not visible in FIG. 1 (see, e.g., FIG. 2), each audio device may include processing circuitry (e.g., including memory and/or one or more processors) and communications circuitry (e.g., one or more antennas, etc.) for receiving and/or processing audio content and/or control signals from one or of the electronic device 104, the electronic device 110, the electronic device 115, and/or the server 120, and/or for providing audio data and/or other signals to the electronic device 104, the electronic device 110, the electronic device 115, and/or the server 120. The processing circuitry of the audio device 150 may operate the speaker 152 to generate the sound. The memory may store one or more machine learning models and/or one or more rules-based processes for performing one or more operations described herein.

The audio device 150 may include communications circuitry for communications (e.g., directly or via network 106) with the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The electronic device 104 , the electronic device 110, an electronic device 115, and/or the server 120 may include communications circuitry for communications (e.g., directly or via network 106) with audio device 150 and/or with the others of the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios.

In one or more implementations, the audio device 150 may also include one or more machine learning models that are trained to recognize the voice of user 101, any of various verbal commands from the voice of user 101, and/or any of various standardized sounds such as police or ambulance sirens, smoke or fire alarms, and/or travel announcements (e.g. station announcements, or bus stop announcements).

The audio device 150 may be communicatively coupled to a companion device, such as the electronic device 104, the electronic device 110, and/or the electronic device 115. Such a companion device may, in general, include more computing resources and/or available power in comparison with the audio device 150. In one or more implementations, memory of the electronic device 104, the electronic device 110, and/or the electronic device 115 may store code and/or instructions for one or more applications, such as a translation application. In one or more implementations, memory of the electronic device 104, the electronic device 110, and/or the electronic device 115 may store one or more machine learning models trained to perform one or more portions of the translation operations described herein. The electronic device 104, the electronic device 110, and/or the electronic device 115 may also include one or more machine learning models that are trained to recognize the voice of user 101, any of various verbal commands from the voice of user 101, and/or any of various standardized sounds such as police or ambulance sirens, smoke or fire alarms, travel announcements (e.g. station announcements, or bus stop announcements), based on audio data received from the audio device 150.

The audio device 150 may operate in various modes. For instance, the audio device 150 can operate in a first mode of operation (e.g., a transparent mode of operation), in which environmental sounds are passed, by the speaker(s) of the audio device 150, through to the ear(s) of the user 101. In this first mode of operation, audio content, such as translated audio and/or media content (e.g., received from electronic device 104) may be output by the speaker 152 of the audio device 150 without noise-cancelling content and to allow and/or enhance external sounds for pass-through to the user while the audio content plays. The audio device 150 may operate in a second mode of operation (e.g., a noise-cancelling mode of operation, such as an active noise cancellation (ANC) operation), in which one or more microphones of the audio device 150 are used to receive ambient sounds, and processing circuitry of the audio device 150 generates an anti-noise signal for cancelling the ambient sounds (e.g., and/or an error signal from an error microphone is used to cancel residual environmental noise), to prevent the environmental sounds from reaching the ear of the user 101. In this second mode of operation, audio content (e.g., translated audio content and/or media content, such as music, podcasts, audio associated with an application, a game, a video, etc.) may be played combined with noise cancellation content (e.g., an anti-noise signal that is generated, based on environmental sounds received by one or more microphones of the audio device 150 to destructively interfere with, and thereby cancel, the environmental sounds) by the audio device.

In one or more implementations, the audio device 150 may operate in an automatic adaptive noise cancellation mode. For example, in some use cases, the physical body of the audio device 150, and/or ANC operations can also block or cancel ambient sounds that the user may desire to hear. These desirable ambient sounds may include the sound of a voice of a person (e.g., having a conversation with the user or in a performance being viewed by the user), an alert or notification sound, or the like.

In one or more implementations, in an automatic adaptive noise cancellation mode, an adjustable headphone/earbud pass-through signal with a flat frequency response at various adjusted levels may be provided. This can be achieved by mixing a pass-through audio signal with an active noise cancellation (ANC) signal according to a mixing curve that defines a mixing value as a function of the ambient sound level. The mixing curve can be different for different operational states of a device. The different operational states can include operational modes of the device itself (e.g., telephony, conversation, downlink, translation), environmental conditions (e.g., stationary noise, such as in an airplane) in a physical environment of the device, and/or user states (e.g., motion states of the user of the device, such as walking or running while carrying/wearying a device). When multiple operational states are present, a priority table can be used to select the mixing curve.

Audio device 150 may also include one or more sensors such as touch sensors and/or force sensors for receiving user input. For example, a user/wearer of audio device 150 may tap a touch sensor or pinch the force sensor briefly to control the audio content being played, to control volume of the playback, to start or end a translation session, and/or to toggle between the transparent and noise-cancelling (e.g., automatic adaptive noise cancellation) modes of operation. In one or more implementations, the user may hold down the force sensor while the audio device is operated in the noise-cancelling mode of operation to temporarily switch to the transparent mode of operation until the force sensor is released. In one or more implementations, the user 101 may provide an input to the sensor(s) 151 to enable or disable a translation operation at the audio device 150 and/or at a companion device, such as the electronic device 104, the electronic device 110, and/or the electronic device 115.

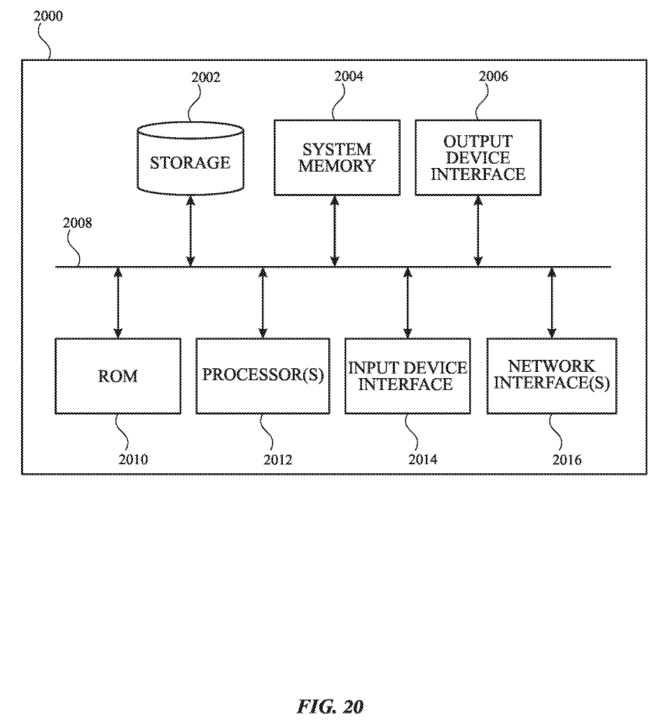

The electronic device 104 may be, for example, a portable computing device, such as a smartphone, a laptop computer, a peripheral device (e.g., a digital camera, headphones), a tablet device, a wearable device such as a smart watch, a smart band, and the like, any other appropriate device that includes, for example, processing circuitry and/or communications circuitry for providing audio content to audio device(s) 150. In FIG. 1, by way of example, the electronic device 104 is depicted as a mobile smartphone device with a touchscreen. In one or more implementations, the electronic device 104 and/or the audio device 150 may be, and/or may include all or part of, the electronic device discussed below with respect to the electronic system discussed below with respect to FIG. 20.

The electronic device 110 may be, for example, a portable computing device, such as a smartphone, a tablet device, a laptop computer, a peripheral device (e.g., a digital camera, headphones), a tablet device, a wearable device such as a smart watch, a smart band, and the like, any other appropriate device that includes, for example, processing circuitry and/or communications circuitry for providing audio content to audio device(s) 150. In FIG. 1, by way of example, the electronic device 110 is depicted as a tablet device with a touchscreen. In one or more implementations, the electronic device 104 and/or the audio device 150 may be, and/or may include all or part of, the electronic device discussed below with respect to the electronic system discussed below with respect to FIG. 20.

The electronic device 115 may be, for example, desktop computer, a portable computing device such as a laptop computer, a smartphone, a peripheral device (e.g., a digital camera, headphones), a tablet device, a home hub device, or a wearable device such as a watch, a band, and the like. In FIG. 1, by way of example, the electronic device 115 is depicted as a desktop computer. However, this is merely illustrative. In some implementations, the electronic device 115 may be implemented as a home-control device (e.g., a hub device or other device) that is communicatively coupled to one or more network-connected devices in a home or building, and that is configured to generate control signals for operating the one or more network-connected devices. The electronic device 115 may be, and/or may include all or part of, the electronic system discussed below with respect to FIG. 20.

In one or more implementations, two or more of the devices of FIG. 1 may be owned by and/or registered to an account of the same user. For example, the audio device 150 and the electronic device 104 (e.g., and/or the electronic device 110 and/or the electronic device 115) may be owned by, registered to (e.g., with the server 120), and/or logged into an account of the user 101.

The server 120 may form all or part of a network of computers or a group of servers 130, such as in a cloud computing or data center implementation. For example, the server 120 stores data and software, and includes specific hardware (e.g., processors, graphics processors and other specialized or custom processors, such as for user authentication and/or authorization, account services, and/or streaming media content to the electronic device 104, the electronic device 110, and/or the electronic device 115. In an implementation, the server 120 may function as a cloud storage server. In one or more implementations, the server 120 may store machine-learning models trained to translate audio data including speech in one or more first languages (e.g., English, French, Spanish, Dutch, German, Swedish, Hindi, one or more Chinese languages, or the like) into audio data including computer-generated speech in one or more second languages (e.g., one or more others of English, French, Spanish, Dutch, German, Swedish, Hindi, one or more Chinese languages, or the like). Translation models may be configured to translate one language into one other language, multiple different languages into one language, or multiple different languages into multiple other different languages. In one or more implementations, the audio device 150, the electronic device 104, the electronic device 110, and/or the electronic device 115 may obtain one or more of the translation models for execution at the audio device 150, the electronic device 104, the electronic device 110, and/or the electronic device 115. For example, the user 101 may select from one or more target translation languages using a user interface of a translation application at the audio device 150, the electronic device 104, the electronic device 110, and/or the electronic device 115, which may cause that device to download the corresponding translation model(s) in those one or more selected target translation applications. For example, an English-to-French translation model may be downloaded to the audio device 150, the electronic device 104, the electronic device 110, and/or the electronic device 115 prior to or during travel of an English-speaking person to France or another francophone country.

FIG. 2 illustrates an example implementation in which the audio device 150 is in a noise cancellation mode during a translation operation. As shown in FIG. 2, the audio device 150 may include processing circuitry 202, a speaker 152, one or more sensors 204, and/or one or more microphones 206. The processing circuitry may include one or more processors, memory, and/or communications circuitry for (e.g., wired or wireless) communication with another device, such as the electronic device 104, the electronic device 110, the electronic device 115, and/or the server 120 of FIG. 1. For example, the sensors 204 and the microphones 206 may be implementations of the sensors 151 of FIG. 1.

As shown, the audio device 150 may include multiple microphones 206. The multiple microphones 206 may include a microphone 206 positioned (e.g., behind the speaker 152) to receive environmental sounds, a microphone 206 positioned (e.g., nearest to the wearer’s mouth) to receive voice input from the wearer, and/or a microphone 206 positioned (e.g., in front of the speaker 152) as an error microphone for detecting sounds (e.g., residual, or uncancelled environmental sounds) in or near the ear canal of the wearer. The sensor(s) 204 may include inertial measurement unit (IMU) sensors (e.g., accelerometers, magnetometers, and/or gyroscopes), proximity sensors, touch sensors, force sensors, and/or other sensors. In the example, of FIG. 2, the audio device 150 is implemented as an earbud, and may be one of a pair of earbuds having the same or similar components and configured for wired or wireless communication between the earbuds of the pair.

In the example of FIG. 2, the user 101 may be attempting to have a conversation with a person 201, other than the user 101 (e.g., or the person 201 may be a performer in a performance being viewed by the user 101). In one example use case, the user 101 may be able to speak and understand one language, such as English, and the person 201 may be able to speak and understand a different language, such as Spanish. The user 101 may not be able to speak or understand (e.g., or may have only a limited ability to speak and understand) the other language of the person 201. In order, for example, to facilitate such a conversation, the audio device 150 (e.g., and/or a companion device associated therewith) may perform a translation operation that translates speech (e.g., including words, phrases, sentences, etc.) from the person 201 in the second language (e.g., Spanish) into an audio output that includes a computer generated translation, in the first language (e.g., English), of the speech of the person 201 in the second language.

For example, a voice 222 of the person 201 may be received by one or more of the microphones 206 of the audio device 150. Input audio data, such as a microphone signal that includes a representation of the voice 222 of the person 201, may be provided to processing circuitry 202 of the audio device 150. As shown, translated audio data may be provided to the speaker 152 of the audio device 150, which may then generate an audio output 225 (e.g., a translated audio output), corresponding to the translated audio data, that includes a computer-generated translation of the voice 222 of the person 201. In this way, the audio device 150 may allow the user 101 to understand the speech of the person 201 substantially in real time as the person 201 speaks (e.g., with a delay of one or two seconds or less than one second), even if the person 201 is speaking in a language that the user 101 does not understand.

As shown, one or more other sound sources, such as a sound source 287, may also generate sound 289 (e.g., noise, ambient sound, background sound(s), and/or ambient noise) in the physical environment of the audio device 150. As examples, the sound source 287 may be one or more other people speaking, vehicle noise, traffic noise, airplane noise, train noise, a dog barking, music, soundtrack sounds, or any other source of sound. In one or more use cases, the translation operations described herein may be performed concurrently with noise-cancellation operations to cancel the sound 289 (e.g., in the ear canal of the user 101). For example, the processing circuitry 202 may provide noise cancellation content to the speaker 152 for output concurrently with the translated audio data. However, as discussed herein, during a translation session, at some times, the user 101 may be speaking, and, at other times, a computer-generated translation of the speech of the person 201 may be output by the speaker 152. A constant amount of noise cancellation, or even adaptive noise cancellation for a conversation mode (e.g., in which noise cancellation is reduced when another person is speaking to allow the other person’s voice to pass through to the ear of the user 101) may not be conducive to the translation mode. In accordance with aspects of the subject technology, and as discussed in further detail hereinafter, the audio device 150 may modify the noise cancellation operation in a specific way for the translation session, such as by increasing the amount of noise cancellation when the translated audio data is being output by the speaker 152 (e.g., to suppress or cancel the sound 289 to allow the user 101 to better hear the translated audio) and decreasing the amount of noise cancellation when the user 101 is talking (e.g., to allow the user 101 to hear their own voice as they would if the audio device 150 were not present in or around their ear(s)). In some implementations, increasing the noise cancellation when the translated audio data is being output by the speaker 152 also help to cancel the user’s own voice so that the user can hear the translated audio over their own voice. In other implementations, translated audio may be paused when the user is speaking.

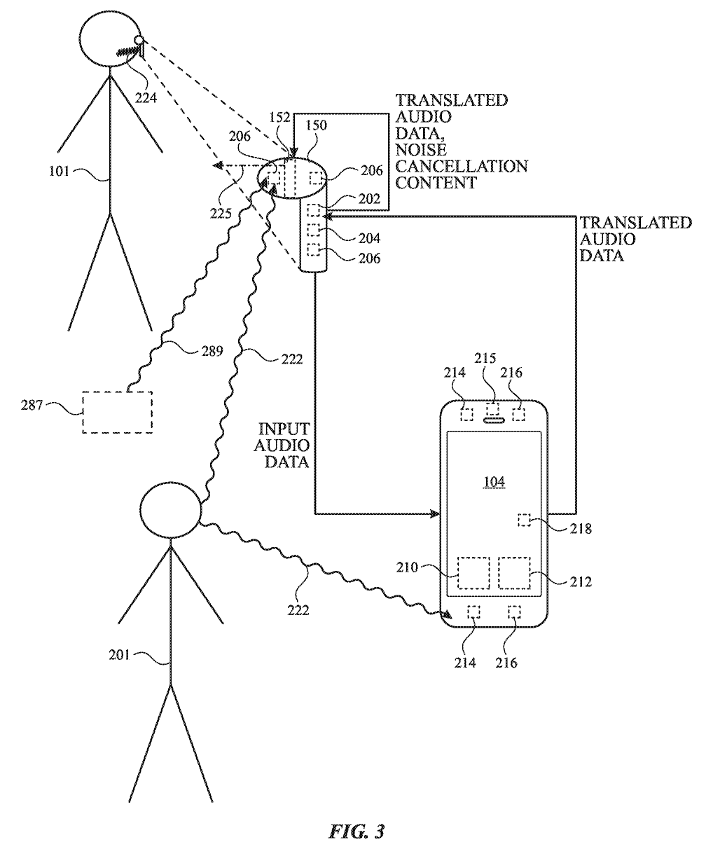

In various implementations, the translated audio data may be generated at the audio device 150 (e.g., the processing circuitry 202 may generate, responsive to receiving the input audio data from the microphone(s) 206, the translated audio data) or at another device, such as a companion device of the audio device 150 (e.g., a device that is paired with and connected to the audio device 150). For example, FIG. 3 illustrates an implementation in which the electronic device 104 operates as a companion device to the audio device 150 of the user 101 during a translation operation, in accordance with aspects of the subject disclosure.

The electronic device 104 may include processing circuitry 210, memory 212, communications circuitry 215, one or more speakers 216, one or more microphones 214, and/or one or more sensors 218. As shown, the electronic device 104 may include multiple microphones 214 at various locations. The sensor(s) 218 may include a light sensor, inertial measurement unit (IMU) sensors (e.g., accelerometers, magnetometers, and/or gyroscopes), proximity sensors, touch sensors, force sensors, and/or other sensors.

In the example of FIG. 3, the electronic device 104 may perform a translation operation that translates speech (e.g., including words, phrases, sentences, etc.) from the person 201 in the second language (e.g., Spanish) into an audio output that includes a computer generated translation, in the first language (e.g., English), of the speech of the person 201 in the second language.

For example, the voice 222 of the person 201 may be received by one or more of the microphones 206 of the audio device 150 and or by one or more microphones 214 of the electronic device 104. Input audio data, such as a microphone signal that includes a representation of the voice 222 of the person 201, may be transmitted from the audio device 150 to the electronic device 104 (e.g., a companion device). A translation application running at the electronic device 104 may generate translated audio data responsive to receiving the input audio data from the audio device 150 and/or microphone signals from the microphones 214 of the electronic device 104. As shown, the translated audio data may be transmitted from the electronic device 104 to the audio device 150. The speaker 152 of the audio device 150 may then generate an audio output 225, corresponding to the translated audio data, that includes a computer-generated translation of the voice 222 of the person 201. In this way, the electronic device 104 and the audio device 150 may allow the user 101 to understand the speech of the person 201 in substantially in real time as the person 201 speaks (e.g., with a delay of one or two seconds or less than one second), even if the person 201 is speaking in a language that the user 101 does not understand. In the example of FIG. 3, the processing circuitry 202 of the audio device 150 may generate noise cancellation content for output in the audio output 225 concurrently with the translated audio data (e.g., received from the electronic device 104) in the audio output 225.

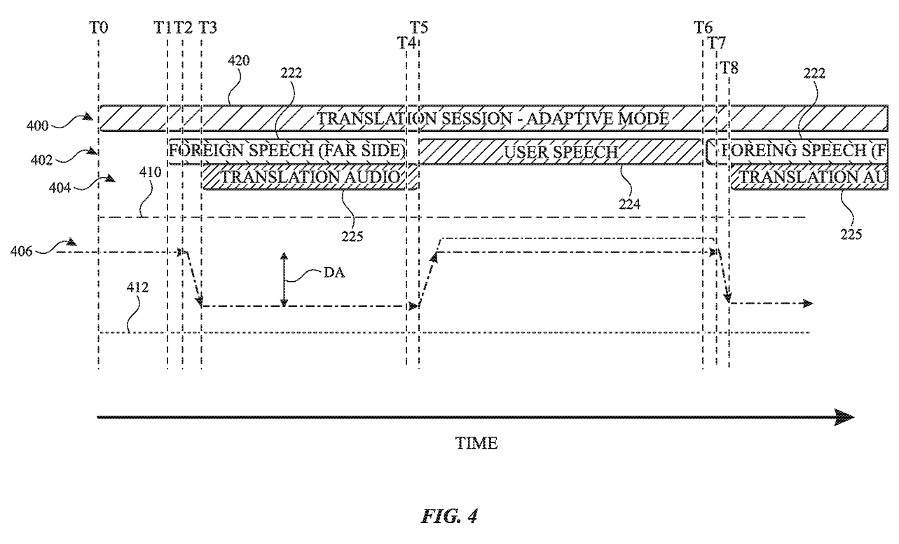

FIG. 4 is a timing diagram that illustrates example modifications to a noise cancellation operation during a translation session. FIG. 4 includes a timeline 400 of a translation session 420, a timeline 402 activity (e.g., activity of the voice 222 of the person 201 and/or the voice 224 of the user 101), a timeline 404 of translated audio output 225 (e.g., by the speaker 152), and a timeline 406 of the amount (e.g., an amount of attenuation, such as in negative decibels (dB)) of noise cancellation that is performed during the translation session.

For example, the processing circuitry 202 of the audio device 150 and/or the processing circuitry 210 of the electronic device 104 may operate one or more voice activity detectors (VADs) that generate VAD signals that indicate when one or more voices (e.g., the voice 222 of the person 201 and/or the voice 224 of the user 101) are active (e.g., present in a microphone signal from the microphone(s) 206 of the audio device 150 and/or the microphone(s) 214 of the electronic device 104). For example, the VAD(s) may receive the microphone signal, and may determine, from the microphone signal, whether one or more voices are present. For example, the VAD(s) may include an own voice activity detector (OVAD) and a target voice activity detector (TVAD). The OVAD may be configured to detect the voice 224 of the user 101. The TVAD may be configured to detect the voice 222 of the person 201 other than the user 101. As examples, the OVAD may be trained on the user’s own voice, trained based on speech in the user’s own language, and/or configured to detect the user’s own voice based on a (e.g., approximately) known location of the user’s mouth relative to the audio device 150 (e.g., based on near-field characteristics of the user’s voice in close proximity to the microphones 206 of the audio device 150, such as different arrival times of the voice 224 at different microphones of the audio device 150). As examples, the TVAD may be trained to detect speech in another language and/or to detect a speaker other than the user based on location information for a target speaker other than the user (e.g., responsive to detection of far-field characteristics of a person’s voice in the microphone signals from the microphones 206, such as a common, or same, arrival time of the voice 222 at the microphones of the audio device 150 and/or the electronic device 104).

In one or more implementations, the OVAD of the VAD(s) may generate a first VAD signal (e.g., VAD1) that indicates whether the user’s own voice (e.g., voice 224) is present in the microphone signal (e.g., between times T5 and time T6 in FIG. 4), and the TVAD of the VAD(s) may generate a second VAD signal (e.g., VAD2) that indicates whether the voice (e.g., voice 222) of a target person (e.g., person 201) is present in the microphone signal (e.g., between times T1 and T4 and after time T6 in FIG. 4). In one or more implementations, the first VAD signal and the second VAD signal may each include a binary value indicating speech vs. non-speech of the corresponding user/person.

As shown in FIG. 4, the noise cancellation operation may apply an initial amount of attenuation (e.g., between a minimum attenuation 410, such as zero dB attenuation, and a maximum attenuation, such as -20, -25, -30, or -35 dB) before the translation operation begins (e.g., at T0). It is appreciated that, in the example of FIG. 4, the timeline 406 goes up (e.g., representing more ambient sound passing through) when less attenuation is applied, and goes down (e.g., representing less ambient sound passing through) when more attenuation is applied (e.g., because the attenuation may be expressed in negative dB extending downward from zero dB attenuation). The attenuation of timeline 406 may represent an amount (e.g., sometimes referred to herein as the amount of noise cancellation) by which the ambient noise is suppressed in the user’s ear canal, relative to the amount of the ambient sound at the microphone(s) 206 external to the ear canal. For example, the initial amount of attenuation (e.g., before the translation session 420 begins) may be an automatically adaptive amount that varies (e.g., between the minimum attenuation 410 and the maximum attenuation 412) based on the amount of noise (e.g., a sound pressure level, SPL, of the ambient noise, as measured using one or more of the microphone signals) in the physical environment of the audio device 150. In one or more implementations, and discussed in further detail hereinafter, this initial amount of attenuation may be determined by obtaining a mixing value (MV) from a mixing curve, and mixing a noise cancellation signal with a pass-through signal in respective amounts that are determined based on the mixing value.

As shown in FIG. 4, when the voice 222 of the person 201 is active (e.g., between times T1 and T4 and after time T6 in FIG. 4), the amount of attenuation applied by the noise cancellation operation may be increased. Because there is some latency between the start of the voice 222 (e.g., at times T1 and T6) and the output (e.g., at times T3 and T8) of the translated audio for the voice 222 (e.g., due to the time consumed for performing the translation and/or transmitting data between the audio device 150 and the electronic device 104), the noise cancellation operation may be increased over a period of time (e.g., between times T2 and T3 and between times T7 and T8) between when the person 201 begins talking and when the translation of the person 201 is output by the speaker 152. As shown, the start of the modification of the noise cancellation operation (e.g., at times T2 and T7) may be between the start of the activity of the voice 222 (e.g., at times T1 and T6) and the start of the output of the translated audio (e.g., at times T3 and T8). In one or more implementations in which the translation is performed at the electronic device 104, when the voice activity of the voice 222 is detected (e.g., time T1 and time T6), the electronic device 104 may transmit a time (e.g., time T3 and time T8) to the audio device 150 at which the translated audio is to be output by the speaker 152, and/or a time (e.g., time T2 and time T7) at which the noise cancellation operation is to be modified. For example, the times T2 and T7 may be determined, by the electronic device 110, based on a known or estimated latency between the start of voice activity and the start of translated audio output.

In the example of FIG. 4, when the voice 222 of the person 201 is not active, and the voice 224 of the user 101 is active (e.g., between times T5 and T6), the amount of noise cancellation may be decreased relative to the amount of noise cancellation when the translated audio is being output. As examples, the amount of noise cancellation may return to the initial amount of noise cancellation that was being performed prior to the beginning of the translation session or may be decreased beyond the initial amount of noise cancellation (e.g., as indicated by the dashed line between times T5 and T6). For example, when the voice 222 of the person 201 is not present, and the voice 224 of the user 101 is present, the amount of noise cancellation may be reduced beyond the initial amount of noise cancellation that was being performed prior to the beginning of the translation session to enhance the user’s ability to hear their own voice 224 when they are talking.

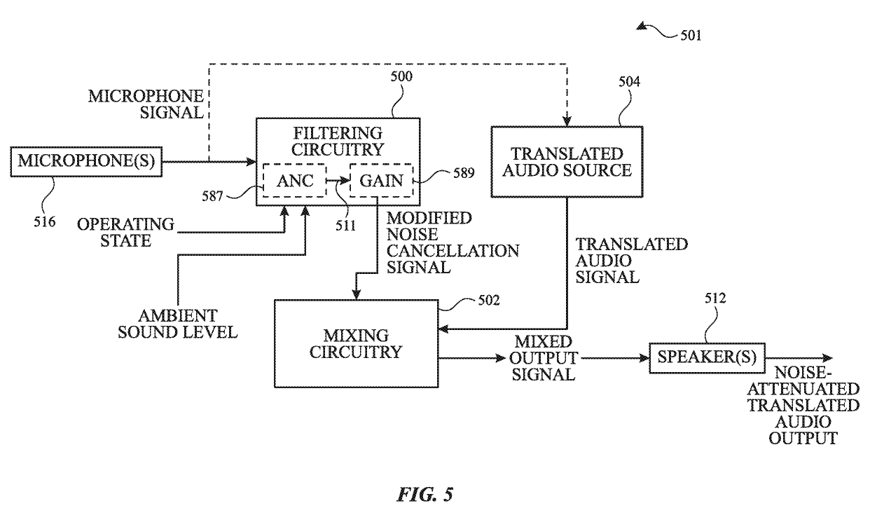

The modifications to the amount of noise cancellation that are illustrated in FIG. 4 during a translation session may be achieved in various ways. For example, FIG. 5 illustrates an implementation in which the amount of noise cancellation is modified by controlling a gain that is applied to a noise cancellation signal generated by an active noise cancellation (ANC) filter. In other implementations, the amount of noise cancellation may be controlled by controlling parameters of the ANC filter itself, by applying a gain to a pass-through audio signal, and/or modifying an amount of mixing of a noise cancellation signal and a pass-through audio signal (e.g., as discussed in further detail hereinafter).

As one example, FIG. 5 is a high-level block diagram of an example architecture 501 that may be implemented in the electronic device 104 to provide automatic adaptive noise cancellation capabilities that are modified for a translation session, in accordance with various aspects of the subject technology. In the example of FIG. 5, the architecture 501 includes one or more microphones 516 (e.g., implementations of the microphone(s) 206 of the audio device 150), processing circuitry including filtering circuitry 500 and mixing circuitry 502, one or more speakers 512 (e.g., one or more implementations of the speaker 152), and a translated audio source 504. In one or more implementations, the translated audio source 504 may be a translator application at the audio device 150 that generates a translated audio signal responsive to receiving a microphone signal (e.g., from microphone(s) 516) that includes a representation of the voice 222 of the person 201. In one or more other implementations, the translated audio source 504 may be communication circuitry (e.g., one or more antennas and/or radio front-end circuitry, which may be implemented as part of the processing circuitry 202 of FIG. 2) that receives translated audio data from another device (e.g., a companion device, such as the electronic device 104 as in the example of FIG. 3). For example, a companion device having a translator application may generates the translated audio signal responsive to receiving a microphone signal (e.g., from one or more microphones 516 and/or one or more microphones, such as microphones 214, at the companion device) that includes a representation of the voice 222 of the person 201, and may transmit the translated audio data to the audio device 150 for output by the speaker(s) 512.

As shown, the microphone signal from one or more microphones 516 may be provided to the filtering circuitry 500. The microphone signal may be provided directly from the microphone 516 to the filtering circuitry 500, or a microphone signal received by the microphone 516 may be pre-processed prior to providing the microphone signal to the filtering circuitry 500. The microphone signal may include representations of one or more sounds (e.g., ambient sounds, such as sound 289, in addition to one or more voices, such as the voice 222 and/or the voice 224 from the physical environment around the audio device 150).

In the example of FIG. 5, an active noise cancellation (ANC) filter 587 of the filtering circuitry 500 may generate a noise cancellation signal 511 based on the microphone signals. The noise cancellation signal 511 may be an anti-noise signal that, when output by a speaker, such as the speaker 512, destructively interferes with the ambient sound in the user’s ear canal to suppress or cancel some or all of that ambient sound. The filtering circuitry 502 may include a gain stage 589 that controls the amount of attenuation (e.g., the amount of noise cancellation) that is provided by the noise cancellation signal 511. For example, the gain stage 589 may apply an adjustable gain to the noise cancellation signal 511, where the adjustable gain is determined based on an ambient sound level in the physical environment of the audio device 150 and/or the electronic device 110. The ambient sound level may be determined (e.g., by a separate process and/or by the filtering circuitry 500) based on the microphone signal from the microphone(s) 516.

For example, the gain stage 589 may increase the gain that is applied to the noise cancellation signal 511 to increase the amount of noise cancellation when the ambient sound level increases, and may decrease the gain that is applied to the noise cancellation signal 511 to decrease the amount of noise cancellation when the ambient sound level decreases. In one or more implementations, and as discussed in further detail hereinafter, the noise cancellation that is performed based on the ambient sound level may depend on an operational state of the audio device 150 and/or the electronic device 110. In some examples that are discussed in further detail hereinafter, the amount of noise cancellation (e.g., the gain that is applied by the gain stage 589) may depend differently on the ambient sound level in different operational states. As shown, an indicator of the operational state may be provided to the mixing circuitry 502 (e.g., by an operating system of the audio device 150 and/or the electronic device 104, and/or by an application, such as the translator application).

For example, when a translation session 420 is active, the mixing circuitry 502 may be instructed to modify the gain that is applied at the gain stage based on whether a translated audio output is being generated and/or whether a user’s own voice is active, as described in connection with FIG. 4. In order, for example, to provide the modified noise cancellation operations described above in connection with FIG. 4, the filtering circuitry 500 (e.g., the gain stage 589) may increase (e.g., relative to an initial gain determined based on the ambient sound level) the gain that is applied to the noise cancellation signal 511 when translated audio is being output by the speaker 512, and/or may decrease the gain (e.g., relative to the initial gain and/or the increased gain) that is applied to the noise cancellation signal 511 when a user’s own voice is active during a translation session. In this way, the filtering circuitry 500 may generate a modified noise cancellation signal (e.g., modified relative to the noise cancellation signal that would be generated by the filtering circuitry 500 based solely on the ambient sound level) for various stages of a translation session 420.

As shown, the modified noise cancellation signal may be provided to the mixing circuitry 502. The mixing circuitry 502 may combine the translated audio signal from the translated audio source 504 with the modified noise cancellation signal to generate a mixed audio signal. The mixed audio signal may be provided to the speaker(s) 512 for output of a noise-attenuated translated audio output. For example, the noise-attenuated translated audio output may include a computer-generated voice speaking the translation of the words spoken by the voice 222 of the person 201, combined with the modified noise cancellation signal. In this way, the ambient noise suppression may be increased when the translated audio output is generated by the speaker, thus enhancing the ability of the user 101 to hear the translated audio output.

In the example of FIG. 5, the gain stage 589 is shown as being part of the filtering circuitry 500. However, in other implementations, the gain stage 589 may be implemented separately from the filtering circuitry (e.g., interposed between the filtering circuitry 500 and the mixing circuitry 502, or integrated with the mixing circuitry 502).

In the example of FIG. 5 a flat (e.g., constant in frequency space) gain is applied to the noise cancellation signal 511. However, frequently increasing and decreasing the amount of noise cancelling (e.g., as may occur during a translation session 420 during which the user 101 and the person 201 are exchanging verbal communications) may cause noticeable (e.g., and sometimes even uncomfortable or disorienting) pressure changes in the ear canal of the user 101. In order, for example, to mitigate the effect of such pressure changes, the gain that is applied to the noise cancellation signal 511 may be a frequency-dependent gain. For example, a frequency-dependent gain may (e.g., effectively) cause the filtering circuitry to function as a low-pass filter on the ambient noise, in which lower frequency ambient sounds are passed through by the audio device 150 more than relatively higher frequency ambient sounds. Low-pass filtering the ambient sounds in this way may reduce the sensation of changing pressure for the user, and/or may generate an effect of muffling or blurring the ambient sounds while still allowing low-frequency portions of the ambient sounds to be heard by the user while the translated audio is output.

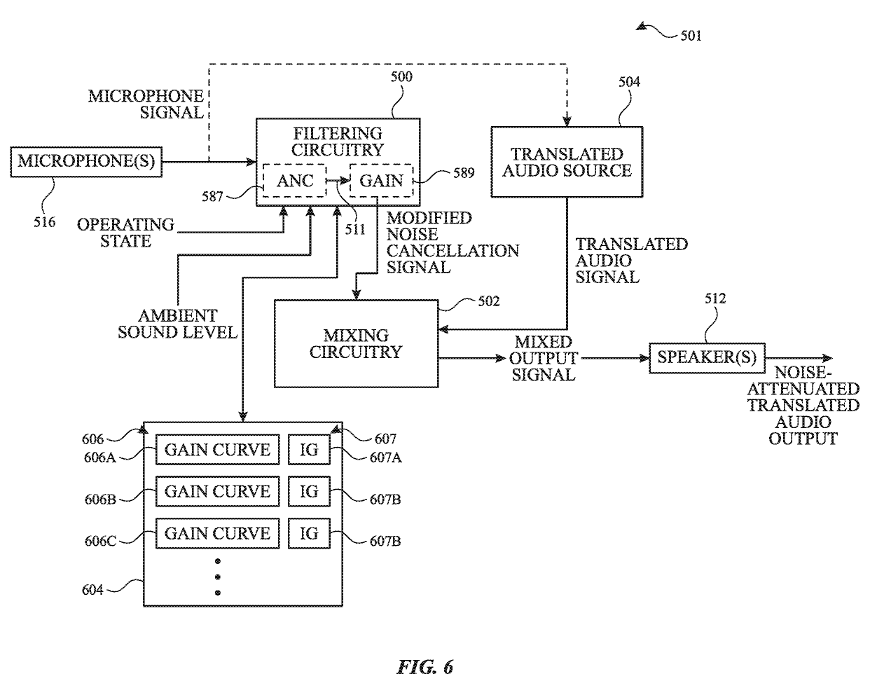

In one or more implementations, the frequency-dependent gain may be defined by one or more the gain curves, which may vary differently for different initial gains that are determined based on the ambient sound level. For example, as shown in FIG. 6, the architecture 501 may include memory 604 (e.g., memory included in the processing circuitry 202 of FIG. 2) that stores one or more gain curves 606. As shown, each of the gain curves 606 may be stored in connection with a corresponding initial gain 607. In the example of FIG. 6, the memory 604 stores a gain curve 606A associated with an initial gain 607A, a gain curve 606B associated with an initial gain 607B, and a gain curve 606C associated with an initial gain 607C. In the example of FIG. 6, the mixing circuitry 502 may determine the initial gain (e.g., which would be applied if no translation session were active), and obtain, from the memory 604, a corresponding one of the gain curves 606. The obtained gain curve 606 may then be applied to the noise cancellation signal 511 (e.g., or implemented by modifying the coefficients of the ANC filter 587 itself) to increase the noise cancellation and thereby decrease the ambient sound in at least a high-frequency (e.g., above 2500 Hz or above 3000 Hz) portion of the ambient sound.

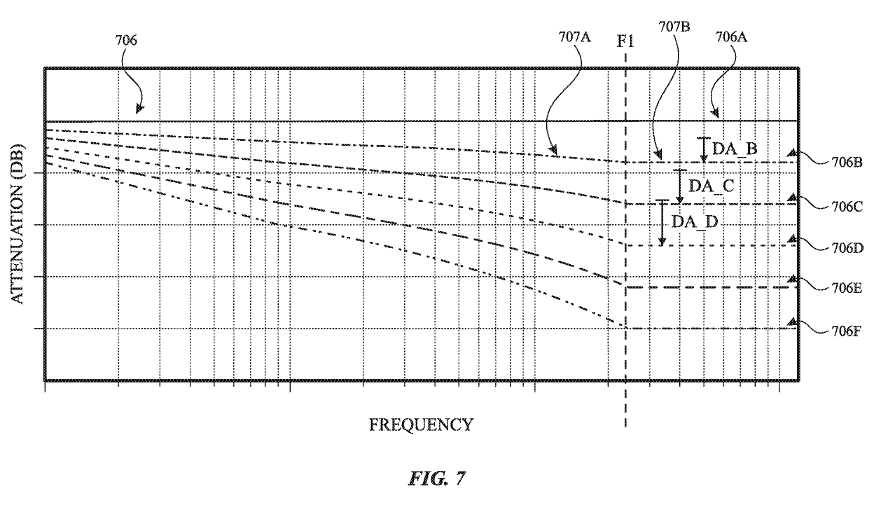

FIG. 7 illustrates various examples of attenuation curves that may result from the application of various gain curves 606 to the noise cancellation signal 511 during a translation session 420. It is appreciated that, in FIG. 7, a lower attenuation may be caused by a higher gain value applied to the noise cancellation signal 511, which results in less ambient noise reaching the ear of the user. As shown in FIG. 7, attenuation curves, such as the attenuation curves 706A, 706B, 706C, 706D, 706E, and 706F, may each identify different attenuations, at different corresponding frequencies, that result from applying corresponding gain curves (e.g., gain curves 606A, 606B, 606C, etc.) to the noise cancellation signal 511. The filtering circuitry 500 (e.g., the gain stage 589) may select a gain curve (e.g., one of the gain curves 606A, 606B, 606C…) for application to the noise cancellation signal 511 received from the ANC filter 587. For example, the gain curve may be selected based on the ambient noise level in the physical environment (e.g., by selecting the gain curve based on the initial amount, such as initial gain 607A, initial gain 607B, initial gain 607C, etc. of gain that is applied by the ANC filter 587 prior to the translation operation, which is dependent on the ambient noise level).

As shown in FIG. 7, in a use case in which the ambient noise is low or non-existent, the initial gain for noise cancellation (e.g., exclusive of translation operation considerations) may be zero. In this use case, a gain curve 606A (e.g., a flat, zero-gain curve) may be selected that results in a flat zero-attenuation curve 706A. As illustrated by the attenuation curve 706B (e.g., resulting from selecting the gain curve 606B based on a non-zero initial gain 607B), as the initial gain increases (e.g., due to an increase in the ambient sound level), a portion 707B of the attenuation at high frequencies (e.g., above a transition frequency, F1) may be attenuated by an amount DA_A more than the attenuation that would result from the initial gain, and progressively less attenuation (e.g., due to progressive lower gains as a function of frequency) may be applied in a portion 707A (e.g., below the transition frequency, F1) of the ambient noise. The attenuation curves 706C, 706D, 706E, and 706F respectively illustrate how respectively higher initial gains (e.g., due to respectively higher ambient noise levels) result in respectively more attenuation (e.g., with relatively larger modifications, DA_C, DA_D, etc. from the attenuation that would result from the respectively higher initial gains) at higher frequencies (e.g., above the transition frequency, F1), and respectively steeper falloff curves in the attenuation moving from the transition frequency F1 toward lower frequencies.

In the examples of FIGS. 5 and 6, the amount of noise cancellation is described as being modified by adjusting the gain applied to the noise cancellation signal 511. In one or more other implementations, the amount of noise cancellation can be modified by modifying one or more parameters of the ANC filter 587 itself.

In the examples of FIGS. 5 and 6, noise cancellation is performed by adding an anti-noise signal (e.g., noise cancellation signal 511) to the output of the speakers 512. However, in one or more implementations, the noise cancellation signal 511 may be mixed with a pass-through audio signal. For example, the frequency response of an ANC-only approach may not be flat through the gain adjustments that occur outside of a translation operation. By mixing the amount of the pass-through audio signal and the noise cancellation signal, the amount of noise cancellation at the user’s ear can be controlled while keeping the frequency response substantially flat across the various amounts of noise cancellation. In one or more implementations, the amount of noise cancellation can be modified by modifying one or more parameters of a pass-through filter that generates the pass-through audio signal, and/or by modifying a gain that is applied to the pass-through audio signal (e.g., by applying a flat gain to the pass-through audio signal or by applying the attenuation curves 706A, 706B, etc. as gain curves to the pass-through audio signal).

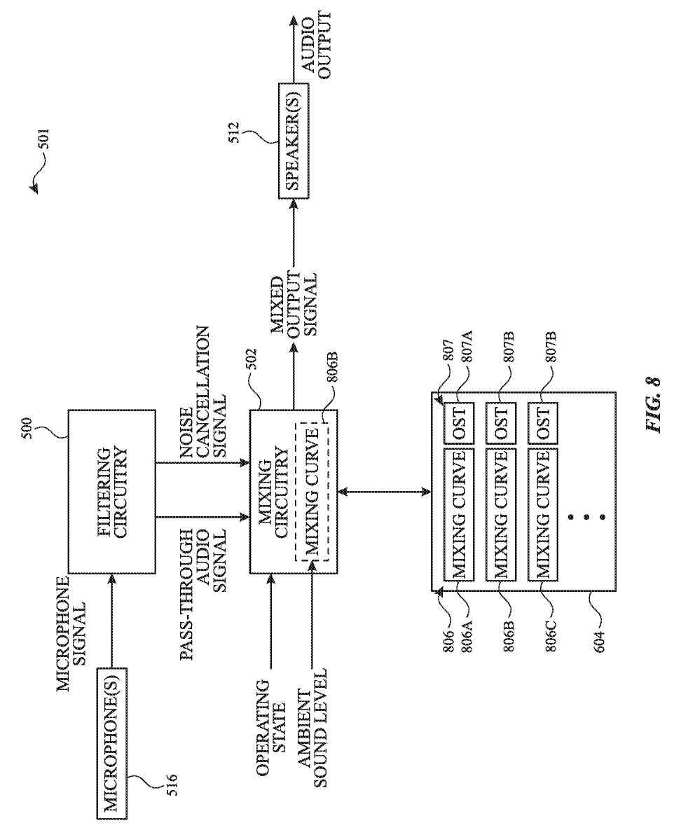

For example, FIG. 8 illustrates an implementation of the architecture 501 in which the filtering circuitry 500 generates, based on the microphone signal from the microphone(s) 516, a pass-through audio signal (e.g., a transparency signal) and the noise cancellation signal 511. For example, the pass-through audio signal may include some or all of the ambient sounds that were included in the microphone signal. As discussed herein, the noise cancellation signal may be an anti-noise signal that is configured to destructively interfere with a portion of the one or more sounds from physical environment that reach the user’s ear (e.g., past any physical blockage of the one or more sounds by a housing of the audio device 150).

As shown, the pass-through audio signal and the noise cancellation signal may be provided to the mixing circuitry 502. As shown, the mixing circuitry 502 may also receive an operational state of the audio device 150. The mixing circuitry 502 may also receive a sound level. For example, the sound level may be a current ambient sound level (e.g., sound pressure level, or SPL) in the physical environment of the audio device 150.

As shown in FIG. 8, the memory 604 may store one or more mixing curves 806. As shown, each of the mixing curves 806 may be stored in connection with a corresponding operational state 807. In the example of FIG. 8, the memory 604 stores a mixing curve 806A associated with an operational state 807A, a mixing curve 806B associated with an operational state 807B, and a mixing curve 806C associated with an operational state 807C. In the example of FIG. 8, the mixing circuitry 502 may obtain, from the memory 604, the mixing curve 806B from among the mixing curves 806 stored in the memory 604. For example, the mixing circuitry 502 may obtain the mixing curve 806B based on the operational state of the audio device 150 (e.g., by determining that the current operational state of the audio device 150 and/or the electronic device 110 corresponds to the operational state 807B). As discussed in further detail hereinafter, each of the mixing curves 806 may be a function of the ambient sound level. For example, the mixing curve 806B may provide, for each ambient sound level in a range of ambient sound levels, a mixing factor. For example, the mixing factor may correspond to a ratio of the pass-through audio signal to the noise cancellation signal in a mixed output signal that includes variable amounts of the pass-through audio signal and the noise cancellation signal.

In one or more implementations in which the mixing circuitry combines a pass-through audio signal with the noise cancellation signal, the amount of noise cancellation may be modified for a translation session 420 by modifying the gain that is applied to the noise cancellation signal, as in the examples of FIG. 5 and 6 (e.g., prior to combining the modified noise cancellation signal with the pass-through audio signal). In one or more other implementations in which the mixing circuitry combines a pass-through audio signal with the noise cancellation signal, the amount of noise cancellation may be modified for a translation session 420 by modifying a gain that is applied to the pass-through signal (e.g., prior to mixing the pass-through signal with the noise cancellation signal) to increase the noise cancellation (e.g., by reducing the pass-through signal) when the translated audio is output, and to decrease the noise cancellation (e.g., by increasing the pass-through signal) when the user’s own voice is active. In one or more other implementations in which the mixing circuitry combines a pass-through audio signal with the noise cancellation signal, the amount of noise cancellation may be modified for a translation session 420 by modifying the mixing value that controls the mix of the pass-through audio signal and the noise cancelling signal. Modifying the mixing value may include selecting a new mixing curve (e.g., stored in the memory 604 in connection with an indicator of an operational state 807 corresponding to the translation operation), or may include modifying the mixing value obtained from a mixing curve 806 to a mixing value that is offset from the mixing curve 806, such as to further attenuate the ambient sound when a translated audio output is being generated by the speaker 512.

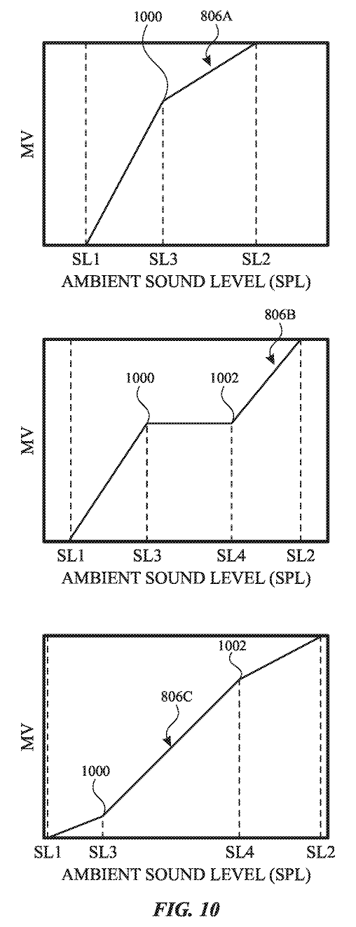

The mixing curves 806 may include linear functions of the ambient sound level, non-linear functions of the ambient sound level, piecewise-defined functions of the ambient sound level, functions of the ambient sound level having one or more inflections points at which the rate of change of the mixing curve changes, monotonically increasing functions of the ambient sound level, functions of the ambient sound level with increasing portions and decreasing portions, and/or any other suitable function of the ambient sound level that are specific to an operational state of an electronic device, illustrative examples of which are described hereinafter in connection with FIG. 10.

As illustrated by the example of FIG. 8, the mixing circuitry 502 may receive an indicator of an operational state of the audio device 150 and/or the electronic device 104, obtain the mixing curve 806B from among the mixing curves 806 based on the operational state, obtain a mixing value from the mixing curve 806B using the received ambient sound level, and generate a mixed output signal by mixing the pass-through audio signal and the noise cancelling signal with a mixing ratio defined by the mixing factor. When the operational state indicator indicates that the operational state includes a translation session 420, the mixing circuitry 502 may select a mixing curve 806 that is specific to the translation session, or the mixing circuitry 502 may continue to obtain the mixing value from a mixing curve that was in use prior to the translation session, and then modify the obtained mixing value for the training session.

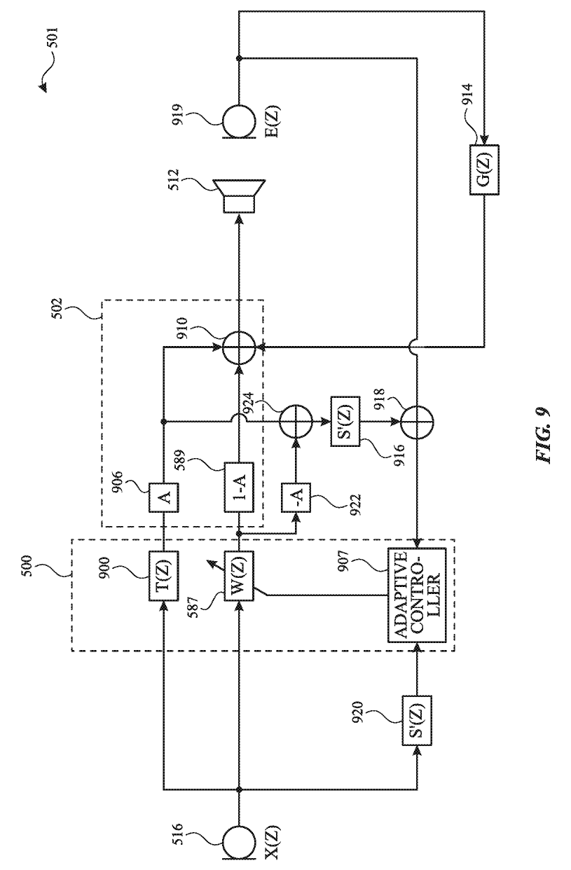

FIG. 9 illustrates additional details that may be included in the architecture of FIG. 8. For example, as shown in FIG. 9, the filtering circuitry 500 may include an active noise cancellation (ANC) filter 587 and a pass-through filter 900. As shown, the mixing circuitry 502 may include the gain stage 589, a gain stage 906, and an adder 910. As shown, the pass-through filter 900 may be configured to receive a microphone signal from the microphone 516, generate the pass-through audio signal based on the microphone signal, and provide the pass-through audio signal to a gain stage 906. For example, the pass-through filter 900 may be configured to generate the pass-through audio signal to include representations of any sounds from the physical environment that are being physically blocked by the housing of the audio device 150 from reaching the ear of the user (e.g., so that the user can experience the acoustic environment as though not wearing or using the audio device 150). As examples, the pass-through filter 900 may be implemented as a finite impulse response (FIR), an infinite impulse response (IIR), or other analog or digital filter having a transfer function which, when the result is output by the speaker 512, causes the output of the speaker 512 to match the input received at the microphone 516 (e.g., as though the audio device 150 s acoustically transparent).

As shown, the ANC filter 587 may generate the noise cancellation signal, and provide the noise cancellation signal to a gain stage 589. In one or more implementations, the ANC filter 587 may include a variation of an optimal filter that can produce an estimate of the ambient sounds by filtering a microphone signal corresponding to the microphone 516 (e.g., an audio signal received directly from the microphone 516 or an audio signal received by the microphone 516 and pre-processed prior to providing the audio signal to the filtering circuitry 500) and can generate a noise cancellation signal (e.g., an anti-noise signal) corresponding to that estimate. For example, an estimate of the ambient sound(s) and a corresponding noise cancellation signal (e.g., anti-noise signal) can be produced, for example, by adaptive prediction and/or by using a prediction filter that exploits a low-pass characteristic of the audio signal. The noise cancellation signal generated by the ANC filter 587 may be adjusted by the gain stage 589 and mixed (e.g., by an adder 910) with the output of the gain stage 906, before the mixed output signal is provided, from the adder 910, for output by the speaker 512. In one or more implementations, the ANC filter 587 and/or the pass-through filter 900 can be implemented at least partially in hardware, firmware or software.

As shown in FIG. 9, the gain stage 906 may apply a gain, A, to the pass-through audio signal that is generated by the pass-through filter 900. As shown, the gain stage 589 may apply a gain corresponding to a complement (e.g., 1-A) of the gain, A, to the noise cancellation signal generated by the ANC filter 587. For example, the gain, (1-A), that is applied to the noise cancellation signal may be a mixing value that is obtained from the mixing curve 806B of FIG. 8 using the current ambient sound level in the physical environment around the electronic device (e.g., as determined from the microphone signal from the microphone 516). In this way, the mixing value (e.g., (1-A)) can be adjusted to control the ratio of the pass-through audio signal to the noise cancellation signal in the mixed output signal that is provided, by the adder 910, to the speaker 512. In this way, the mixing value (e.g., (1-A)) can help control the eardrum sound pressure level at or near the eardrum of the user of the audio device 150 (e.g., by decreasing A (and resultantly increasing (1-A)) to cause more of the noise cancellation signal, relative to the pass-through audio signal, in the mixed output signal, or increasing A (and resultantly decreasing (1-A)) to cause more of the pass-through audio signal, relative to the noise cancellation signal, in the mixed output signal). In one or more implementations, the mixing value (e.g., (1-A)) may be increased (e.g., by decreasing A (and resultantly increasing (1-A)) to cause more of the noise cancellation signal, relative to the pass-through audio signal, in the mixed output signal when a translated audio output is generated by the speaker 512, and/or the mixing value (e.g., (1-A)) may be decreased (e.g., by increasing A (and resultantly decreasing (1-A)) to cause less of the noise cancellation signal, relative to the pass-through audio signal, in the mixed output signal when a user’s own voice is active.

FIG. 9 also illustrates other aspects of the circuitry that can be provided to generate the noise cancellation signal from the ANC filter 587 (e.g., in a way that is compatible with the addition of the pass-through audio signal into the mixed output signal). For example, as shown in FIG. 9, the audio device 150 may include an adaptive controller 907. As illustrated in FIG. 9, the ANC filter 587 may generate a noise cancellation (e.g., anti-noise) signal that, when output by the speaker 512, destructively interferes with ambient sound that leaks past the housing of the audio device 150 and into the user’s ear canal. The leaked ambient noise and the noise cancellation portion of the output of the speaker 512 (based on some or all of the noise cancellation signal generated by the ANC filter 587 and included in the mixed output signal by the mixing circuitry 502) may be combined acoustically in the user’s ear canal, intentionally in a destructive manner so as to result in a very small residual noise or error. As shown, the error microphone 919 (e.g., an implementation of one of the microphones 206) may receive this residual noise or error (e.g., in addition to any user audio content, such as a voice or video call or a one-way digital media streaming or playback session) that is being simultaneously output by the speaker 512, and may provide an error signal to a feedback noise filter 914. As shown, in one or more implementations, the feedback noise filter 914 may generate an anti-residual noise signal that can be mixed into the mixed output signal by the adder 910.

In the example of FIG. 9, the ANC filter 587 may be adaptively controlled by the adaptive controller 907 (e.g., which may be implemented as a coefficient generator for the ANC filter 587). As shown, the adaptive controller 907 may receive a first input (e.g., a feedback signal) that is based on the error signal from the error microphone 919, and a second input that is based on the microphone signal from the microphone 516. For example, the second input may be the microphone signal from the microphone 516, filtered by a modeling filter 920 (e.g., a secondary path modeling filter). As shown, the error signal from the error microphone 919 may be differenced (e.g., by adder 918) with a mixed internal signal from a modeling filter 916 (e.g., a secondary path modeling filter). For example, the modeling filter 916 may receive a combination of the output of the gain stage 906 (e.g., the pass-through audio signal) and an output of a gain stage 922. For example, the gain stage 922 may apply a gain corresponding to a negative of the gain, A, to the output of the ANC filter 587, and provide the resulting signal to the adder 924 for combination (e.g., differencing) with the pass-through audio signal from the gain stage 906.

These first and second input signals may be used by the adaptive controller 907 (e.g., in accordance with a filtered-x, least mean squares (FXLMS) operation), to estimate, for example, primary and secondary path transfer functions. The ANC filter 587 may be an adaptive filter that operates using coefficients that are repeatedly or continually being updated by the adaptive controller 907 so as to drive the error signal from the error microphone 919 to a minimum. It is also appreciated that other adaptive filter algorithms can be used by the adaptive controller 907, including adaptive filter algorithms (e.g., frequency domain adaptive filters (FDAFs)) that use different adaptive filter controllers. When the electronic device is outputting some or all of the noise cancelling signal from the ANC filter 587, the adaptive controller 907 may perform computations that (e.g., continually) adjust or update filter coefficients of the ANC filter 587, in order to adapt the noise cancellation signal to the changing ambient noise and acoustic load seen by the microphone 516 while the user is using the audio device 150. As one illustrative example of how the filter coefficients can be updated, the adaptive controller 907 may implement a leaky, least mean squares (LMS) adaptive algorithm in which a current coefficient is computed based on weighting a prior coefficient. In one or more implementations, the gain stage 922, the adder 924, the modeling filter 916, and the adder 918 can facilitate the use of adaptive noise cancellation in combination with a pass-through signal, as described herein.

As discussed herein, the gain, A, and/or the complement, (1-A), may be determined by a mixing factor that is obtained from a mixing curve 806 (e.g., the complement, 1-A, may be set to the mixing value in some implementations). FIG. 10 illustrates examples of mixing curves from which the mixing factor (and resultingly the gain, A, and its complement) can be obtained. In the example of FIG. 10, three example mixing curves are shown. For example, each of the mixing curves shown in FIG. 10 may correspond to a particular operational state 807 of the audio device 150 and/or the electronic device 104. For example, the mixing curve 806A may be used to obtain a mixing value for a current ambient sound level when the audio device 150 and/or the electronic device 104 is in a telephony mode (e.g., when the user of the audio device 150 is conducting a telephone conversation, an audio conference, or a video conference with audio, using the audio device 150 and/or the electronic device 104), the mixing curve 806B may be used to obtain a mixing value for a current ambient sound level when the user of the audio device 150 is engaged in a (e.g., untranslated) conversation with a person in the physical environment of the audio device 150, and the mixing curve 806C may be used to obtain a mixing value for a current ambient sound level when the user of the audio device 150 is walking or running while wearing or carrying the audio device 150.

However, these three examples of mixing curves and corresponding operational states are merely illustrative, and other mixing curves can be provided for other operational states. In various examples, the operational states may include an operational mode of the audio device 150 itself (e.g., a telephony mode, a downlink mode, an audio playback mode, a translation mode, a performance translation mode, or the like), a state of the user of the audio device 150 (e.g., an in-conversation state, or a motion states, such as a walking state or a running state), a state of a companion device such as the electronic device 104, or an environmental condition in a physical environment around the audio device 150 (e.g., a noise condition, such as a stationary noise state, a dynamic noise state, an airplane noise state, a vehicle noise state, a street noise state, a train noise state, and/or other noise state).

In one or more use cases, the electronic device may detect more than one concurrent operational state. For example, the electronic device may determine that the user of the electronic device is engaged in a conversation while walking in a street noise environment. As another example, the audio device 150 may determine that the audio device 150 is in a translation mode while in a stationary noise environment. As another example, the audio device 150 may determine that the audio device 150 is in an audio playback mode while in a stationary noise environment. In one or more implementations, the audio device 150 may store a priority list that can be used to select a mixing curve 806 that corresponds to a particular operational state 807, in a use case in which multiple operational states 807 are concurrently detected.

In one illustrative example, a telephony mode of the audio device 150 may have a higher priority than a conversation mode of the user of the audio device 150. In another illustrative example, the telephony mode of the audio device 150 may have a priority that is higher than a walking or running mode of the user of the audio device 150. As another illustrative example, a translation mode of the user of the audio device 150 may have a higher priority than an audio output mode of the audio device 150. As another illustrative example, the telephony mode of the audio device 150 may have a higher priority than a stationary noise state of the physical environment. In one or more implementations, when multiple operational states of the electronic device are detected concurrently, the priority list may be used to select the mixing curve of the detected operational state having the highest priority in the priority list. In one or more other implementations, mixing curves for two or more operational states may be combined when the two or more operational states are concurrently detected, and/or one or more mixing curves can be provided for one or more respective specific combinations of operational states.

FIG. 10 also illustrates various aspects of the various mixing curves 806 that can be set for a particular operational mode, in order to control the amount of mixing of the pass-through audio signal and the noise cancellation signal for any given value of the ambient sound level that may occur while the audio device 150 is in that particular operational mode. For example, in the example of FIG. 10, the mixing curve 806A defines a first ambient sound level (SL1) below which only the pass-through audio signal is used in the mixed output signal (e.g., the mixing value, MV, corresponding to (1-A), is zero, and the gain, A, is one) and a second ambient sound level (e.g., SL2) above which only the noise cancellation signal is used in the mixed output signal (e.g., the mixing value, MV, corresponding to (1-A), is one, and the gain, A, is zero). In this example, the mixing curve 806A further defines a variable amount of mixing of the pass-through audio signal and the noise cancellation signal for ambient sound levels between the first ambient sound level (SL1) and the second ambient sound level (SL2). As shown, variable amount of mixing for the ambient sound levels between the first ambient sound level and the second ambient sound level may include a first variation that changes at a first rate for ambient sound levels between the first ambient sound level (SL1) and an inflection point 1000 (e.g., at an ambient sound level, SL3), and a second variation that changes a second rate for ambient sound levels between the inflection point 1000 and the second ambient sound level (SL2). In the example of FIG. 10, the first rate of variation (e.g., the slope of the mixing curve 806A below the inflection point 1000) is greater than the second rate of variation (e.g., the slope of the mixing curve 806A above the inflection point 1000).

As shown in FIG. 10, each of the mixing curves 806B and 806C also includes a first ambient sound level (SL1) below which only the pass-through audio signal is used in the mixed output signal, a second ambient sound level (e.g., SL2) above which only the noise cancellation signal is used in the mixed output signal, and a variable amount of mixing of the pass-through audio signal and the noise cancellation signal for ambient sound levels between the first ambient sound level (SL1) and the second ambient sound level (SL2). However, as shown, the first ambient sound level (SL1), the second ambient sound level (SL2), and the sound level, SL3, at the inflection point 1000 are different for each different mixing curve. As shown, the rates of change between the sound levels SL1, SL2, and SL3 are also different for the different mixing curves. In this way, the variations in the mixing curves 806 can provide varying amounts of mixings of the pass-through audio signal and the noise cancellation signal in the mixed output signal, for various different operational states of the audio device 150. More specifically, a particular ambient sound level that results in a particular mixing value MV when using the mixing curve 806A will result in a different mixing value MV when using the mixing curve 806B or the mixing curve 806C, even if the ambient sound level has not changed.

For example, while in one operational state, the audio device 150 may dynamically adjust the mix of the pass-through audio signal and the noise cancellation signal in the mixed output signal by obtaining, at a first time, a first measure of the current ambient sound level; generate, at substantially the first time, the mixed output signal by obtaining the mixing value, MV, from the mixing curve 806A based on the first measure of the current ambient sound level; obtain, at a second time, a second measure of the current ambient sound level (e.g., following a change in the ambient sound in the physical environment); and generate, at substantially the second time, the mixed output signal by obtaining the mixing value, MV, from the mixing curve 806A based on the second measure of the current ambient sound level. At a later time, the audio device 150 may detect a change in the operational state of the device; obtain, based on detected change in the operational state, the mixing curve 806B; and dynamically adjust the mix of the pass-through audio signal and the noise cancellation signal in the mixed output signal, based on a different mixing value, MV, obtained, from the mixing curve 806B, using a third measure of the current ambient sound level (e.g., which may be the same as or different from the second measure of the current ambient sound level).

In the example of FIG. 10, each of the mixing curves 806B and 806C also includes a second inflection point 1002 (e.g., at an ambient sound level, SL4) at which the rate of change of the mixing value changes. For example, the inflection point 1000 may be a first inflection point, and the second variation that changes at the second rate for ambient sound levels between the inflection point 1000 and the second ambient sound level (SL2) may be a first portion of the second variation. In this example, a second portion of the second variation may change at a third rate (e.g., a third slope of the mixing curve 806B or the mixing curve 806C) for ambient sound levels between the second inflection point 1002 and the second ambient sound level (SL2). As shown, the locations of the inflection point 1000 and the second inflection point 1002 are different for the mixing curve 806B and the mixing curve 806C. Although one or two inflection points are shown in the examples of FIG. 10, it is appreciated that one, two, or more than two inflection points may be included in a mixing curve, and that one or more mixing curves may include increasing and/or decreasing portions, and/or rate changes that occur smoothly (e.g., rather than at a single inflection point).

In one or more implementations, the mixing curves 806 (e.g., including the mixing curve 806A, the mixing curve 806B, and the mixing curve 806C) may be generated empirically and deterministically for each operational state to provide a desired mixed output signal. In one or more other implementations, the mixing curves 806 (e.g., including the mixing curve 806A, the mixing curve 806B, and the mixing curve 806C) may be learned by training a machine learning model (e.g., by adjusting one or more weights and/or other parameters of the machine learning model during a training operation) to output mixing curves based on training ambient sound levels and training output mixing values. In one or more implementations, operational states may be deterministically defined and detected in a rules-based detection process. In one or more other implementations, the operational states may be detected by one or more machine learning models that have been trained (e.g., by adjusting one or more weights and/or other parameters of the machine learning model(s) during a training operation) to output an operational state based on training audio input data, training input device sensor (e.g., IMU) data, based on training input device operational data, and/or training output operational states.

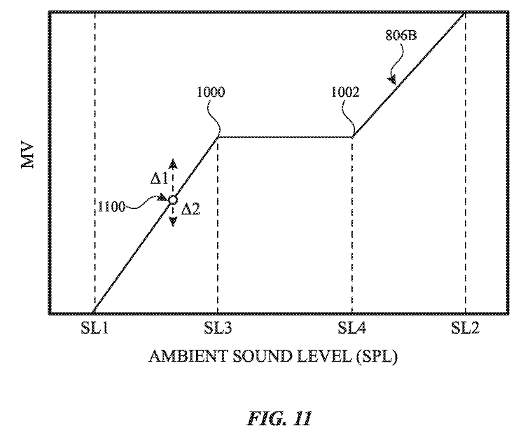

As discussed herein, in one or more implementations, when a translation session 420 is active, a mixing value, MV may be obtained from mixing curve that has been generated for the translation session 420, such as to further suppress the ambient noise when a translated audio output is generated by the speaker 512. As discussed herein, in one or more other implementations, when a translation session 420 is active, a mixing value, MV, obtained from a mixing curve for another operational state may be modified (e.g., by a predetermined amount), such as to further suppress the ambient noise when a translated audio output is generated by the speaker 512. For example, FIG. 11 illustrates an example, in which a mixing value 1100 (e.g., obtained for a particular ambient sound level when the mixing curve 806B is in use) may be modified during a translation session 420. For example, when translated audio is being output by the speaker(s) 512, the mixing value 1100 may be modified (e.g., increased) by a first offset, Δ1, so that the noise cancellation is increased while the translated audio is being output by the speaker(s) 512 (e.g., between times T3 and T5 and after time T8 of FIG. 4). During the translation session 420, when the translated audio is no longer being output, the mixing value may return to the mixing value 1100 without the offset, Δ1. During the translation session 420, when the user’s own voice is active, the mixing value 1100 may be unmodified, or may be modified (e.g., decreased) by a second amount, Δ2 (e.g., opposite in sign to the offset, Δ1), so that the noise cancellation is decreased while user’s own voice is active (e.g., as illustrated by the dashed line between times T5 and T7 of FIG. 4).

In the examples described herein in connection with FIGS. 8-11, once a mixing value has been obtained (e.g., based on a selection of the mixing value from the selected mixing curve using the current ambient sound level, and/or offset corresponding to a translation operation), a gain (e.g., 1-A) that is derived from (e.g., is equal to) the mixing value is applied to the noise cancellation signal, and a gain (e.g., A) that is derived from the mixing value is applied to a pass-through audio signal (e.g., from the pass-through filter 900). As discussed herein in connection with FIG. 7, the mixing value, MV (e.g., including the offset, Δ1, when translated audio is being output), may set the full gain in a portion 707B of the ambient sound, and the gain may be frequency dependent, based on a gain curve 606) at other (e.g., lower) frequencies.

In various examples described herein, a single gain across all frequencies of the pass-through signal has been described. However, in one or more implementations, a gain (e.g., A) that is applied to the pass-through signal may be frequency dependent (e.g., A(f)). For example, the attenuation curves 706 of FIG. 7 (e.g., described in connection with FIG. 7 as resulting from applying corresponding gain curves to the noise cancellation signal) may alternatively be (e.g., scaled and) applied as gain curves to the pass-through signal from the pass-through filter 900 (e.g., reducing the pass-through signal more at relatively higher frequencies to suppress those higher frequency ambient sounds and to allow the lower frequency ambient sounds to progressively pass through in higher amounts with decreasing frequency). In this example, an attenuation curve 706 for the pass-through signal may be selected (e.g., from among the attenuation curves 706A, 706B, 706C, etc.) based on an associated mixing value from a currently utilized mixing curve. In one or more other implementations, the gain that is applied to the pass-through audio signal may vary with frequency in a way that depends on the amount of noise cancellation being performed (e.g., based on the mixing value) and/or according to user input indicating a preference for an amount of pass-through ambient sound desired by the user.

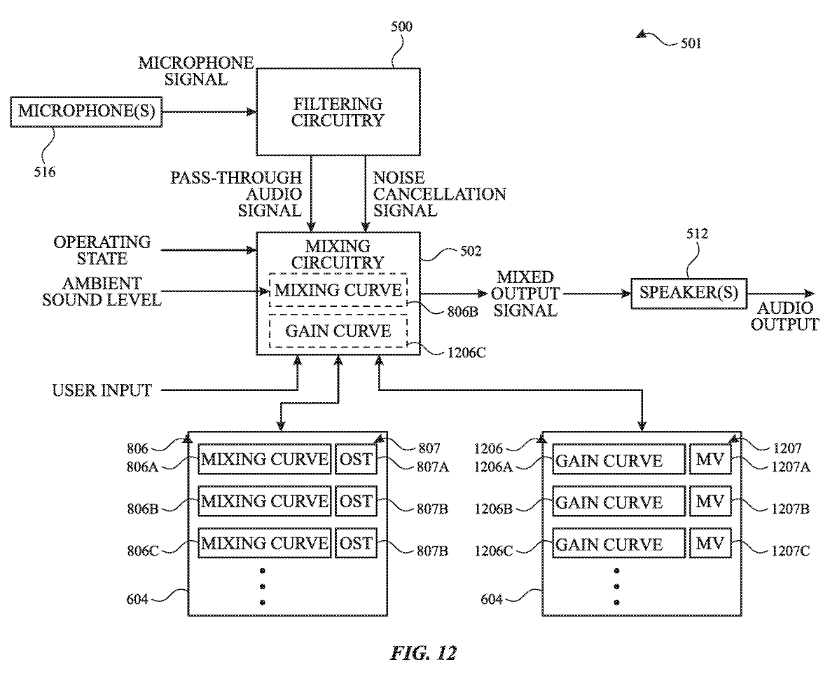

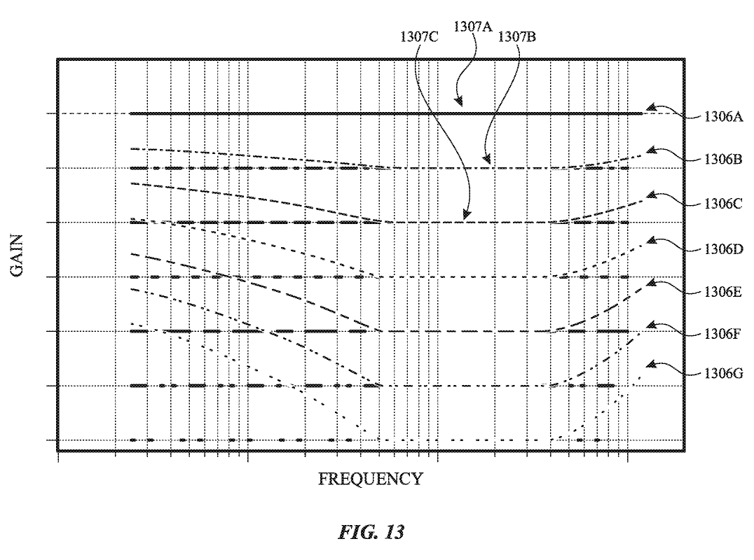

For example, FIG. 12 illustrates the example architecture 501 of FIG. 5 in an implementation in which the gains that are applied to the noise cancellation signal and/or the pass-through audio signal may vary with frequency in a way that depends on the ambient sound level (e.g., and/or on the mixing value). As shown in the example of FIG. 12, once a mixing value (MV) has been obtained (e.g., from a mixing curve that has been obtained based on an operational state of the audio device 150 and/or the electronic device 104, and which may be modified based on a user input or may be unmodified in the absence of a user input), the mixing circuitry 502 may obtain a gain curve 1206 based on the mixing value (e.g., a mixing value 1207 in the example of FIG. 12). In the example of FIG. 12, the mixing circuitry 502 has obtained a gain curve 1206C based on a mixing value 1207C (e.g., obtained by extracting the mixing value that corresponds to the ambient sound level from the selected mixing curve 806B), from among multiple gain curves (e.g., gain curves 1206A, 1206B, 1206C, etc.) that are each stored in association with a corresponding mixing value (e.g., mixing values 1207A, 1207B, 1207C, etc.). For example, each of the gain curves 1206A, 1206B, 1206C, etc. may identify several different gains (e.g., 1-A, or A) to be applied to the noise-cancellation signal or the pass-through audio signal at each of several different corresponding frequencies (e.g., as discussed in further detail hereinafter in connection with FIGS. 13-15). It is appreciated that the gain curve may correspond to specific a mixing value (e.g., an amount of noise cancellation, which may be based on an amount of ambient sound), but not necessarily to a specific mixing curve (e.g., because the same mixing value can be obtained, at various different times from various different mixing curves having various different mixing values for the same ambient sound level, if the ambient sound level and/or the operating state changes). It is also appreciated that, rather than storing a set of gain curves each in association with a mixing value as in the illustrative example of FIG. 12, the gain curves can be obtained from a mixing value in other ways (e.g., by providing the mixing value into a computation from which the gain curve is derived, or by providing the mixing value to a machine learning model that has been trained to provide a gain curve based on a mixing value).

In one or more implementations, the gain curves 1206A, 1206B, 1206C, etc., may correspond, respectively, to the gain curves 606A, 606B, 606C, etc. of FIG. 6, and may define gains (e.g., 1-A) that are applied to the noise cancellation signal (e.g., to increase the noise cancellation signal at high frequencies while progressively reducing the noise cancellation signal at relatively lower frequencies when translated audio is being output by the audio device 150). In one or more other implementations, the gain curves 1206A, 1206B, 1206C, etc., may take the form of the attenuation curves 706A, 706B, 706C, etc. of FIG. 7, and may define gains (e.g., A) to be applied to the pass-through signal (e.g., to decrease the pass-through audio signal at high frequencies while progressively increasing the pass-through audio signal at relatively lower frequencies when translated audio is being output by the audio device 150). In one or more other implementations, the mixing circuitry 502 may obtain and apply gain curves to both the noise cancellation signal and the pass-through audio signal to effect the attenuation shown by the attenuation curves 706A, 706B, 706C, etc. of FIG. 7 when translated audio is being output by the speaker 512.

As discussed above in connection with FIG. 7, the gain curves that are applied when translated audio is being output by the speaker 512 may be configured to suppress the high-frequency (e.g., greater than frequency, F1) portions (e.g., portion 707B) of the ambient noise, and to progressively pass more of the ambient noise moving toward lower frequencies (e.g., to generate a blurring or muffling effect on the ambient noise, which reducing or avoiding noticeable pressure changes in the user’s ear canal). These gain curves may be in contrast to other gain curves that may be applied when no translation session is active (or when no translated audio is being output during a translation session) and/or when a translation session is being performed for a performance (as discussed in further detail hereinafter).

For example, FIG. 13 illustrates examples of various gain curves that may be applied (e.g., to the pass-through audio signal generated by the pass-through filter 900 or implemented as modifications to the pass-through filter 900) when no translation session is active (or when no translated audio is being output during a translation session). As shown in FIG. 13, gain curves, such as gain curves 1306A, 1306B, 1306C, 1306D, 1306E, 1306F, and 1306G may each identify several different gains (e.g., A(f)) for the pass-through audio signal at each of several different corresponding frequencies. In various use cases, any of the gain curves 1306A, 1306B, 1306C, 1306D, 1306E, 1306F, and 1306G may be used as any of the gain curves 1206A, 1206B, 1206C, etc. For example, mixing values (e.g., mixing values 1307A, 1307B, 1307C, etc.) obtained from a selected mixing curve may determine the gain for the pass-through signal within a central frequency band (e.g., a frequency band between five hundred Hz and three kHz and including a central frequency fc). In one or more implementations, when a zero gain (e.g., 1-A(fc) = zero, when A(fc)=1) is applied to the noise cancellation signal, a gain curve 1306A for the pass-through signal may be flat across all frequencies. As shown in FIG. 13, as the gain (e.g., 1-A(fc)) that applied to the noise cancellation signal increases (e.g., as A(fc) decreases), the gain curves 1306B, 1306C, 1306D, etc. may define increasing gains A(f) for the pass-through signal at frequencies, f, above and below the central frequency range (e.g., in contrast to a flat, or constant, gain at high frequencies in the case of a translation operation).

For example, in an implementation in which the gain curves of FIG. 13 are not used (e.g., if a single gain, A, is applied across all frequencies of the pass-through signal), this flat attenuation may make the low frequency (e.g., below 300 Hz) and high frequency (e.g., above 6 kHz) components of environmental sounds less audible to a user, because the human ear has less sensitivity at these frequencies when the overall sound level drops (e.g., due to an actual decrease on the overall sound level or due to an increasing gain on the anti-noise signals). In this case, the timbre of the environmental sounds after noise cancellation may be perceived differently by the user from the user’s perception of the same environmental sounds heard with an open ear (e.g., without earbuds or headphones in or on the user’s ear). By applying the gain curves of FIG. 13 instead of a flat (e.g., constant) gain, environmental sounds that are passed through to the ears of the user by headphones or an earbud may be more similar in timbre to the environmental sounds in the absence of headphones or earbuds. In one or more implementations, the gain curves of FIG. 13 may be derived from a loudness model which represents the average perception of human ears. In one or more other implementations, the gain curves of FIG. 13 may be further tuned for an individual user (e.g., to account for a deviation in audio perception of the individual user relative to the average human).

Using the gain curves of FIG. 13 may provide benefits for users who wish to reduce the loudness of environmental sounds while still being able to hear some level of the surrounding environmental sounds in a way that mirrors the way the environmental sounds would be perceived without the loudness reduction. For example, in one example use case, a user in a social setting (e.g., a bar or a party) may desire to receive a less loud and more natural perception of the sounds of the social setting (e.g., to continue enjoy the natural background sounds of the social setting while increasing their ability to have a conversation within the noisy social environment). In another example use case, a user at a concert (e.g., with an 80-90 dBA SPL) may desire to reduce the loudness of the concert (e.g., to around 65~70 dBA SPL) without altering the timbre of the music. In one or more other use cases, applying the gain curves of FIG. 13 may reduce the perceived static ear pressure experienced by some users when noise cancellation is active, by increasing the gain of the low frequency environmental sounds. These use cases may generate different ambient noise priorities for a user than the use case of a translation session 420, during which the user may be attempting to hear a translated audio output from the speaker(s) of the audio device 150, and during which changing amounts of noise cancellation during periods of user speech and translated audio output can create unique pressure changes in the ear canal of the user.

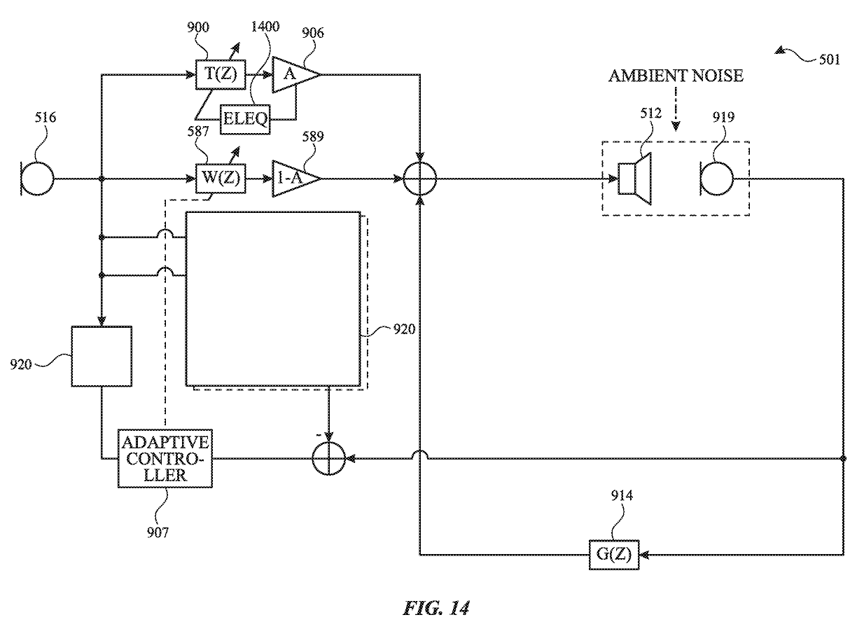

FIG. 14 illustrates the architecture 501, with the addition of an environmental loudness equalizer (ELEQ) 1400. As shown, the ELEQ 1400 may modify, according to a gain curve 1206 selected using a current value of the mixing value, the pass-through audio signal from the pass-through filter 900 as a function of frequency. In one or more implementations, the ELEQ 1400 may apply the gain curve by adjusting the frequency response of the pass-through filter 900 itself (e.g., by adjusting the coefficients of the pass-through filter 900 according to a selected gain curve). For example, the ELEQ 1400 may obtain the mixing value and/or the gain A, and adjust the frequency response of the pass-through filter 900 according to a loudness EQ compensation (e.g., according to a selected gain curve). In one or more other implementations, the gain curve (e.g., the frequency-dependent gain, A(f)) may be applied to the pass-through audio signal by the gain stage 906. In one or more implementations, the gain curve may be used by the pass-through filter 900 and/or the gain stage 906 while a constant (e.g., flat in frequency space) gain (e.g., 1-A, or 1-A(fc)) is applied to the noise cancellation signal from the ANC filter 587. In one or more other implementations, a frequency-dependent gain (e.g., based on a gain curve 1206) may also be applied to the noise cancellation signal from the ANC filter 587. In one or more other implementations, a frequency-dependent gain (e.g., based on a gain curve 1206) may be applied to the noise cancellation signal from the ANC filter 587 while a constant (e.g., flat in frequency space) gain (e.g., A, or A(fc)) is applied to the pass-through signal from the pass-through filter 900.

In one or more implementations, an electronic device, such as the audio device 150, may provide a user with the ability to selectively turn on or off the usage of the gain curves 606 or 1206. For example, some users may prefer the more natural effect of using the gain curves and may turn on the ELEQ 1400. Other users (or the same user at different times or in different acoustic environments) may prefer more noise attenuation over the naturalness of the remaining environmental sounds that pass through, and may turn off the ELEQ 1400.

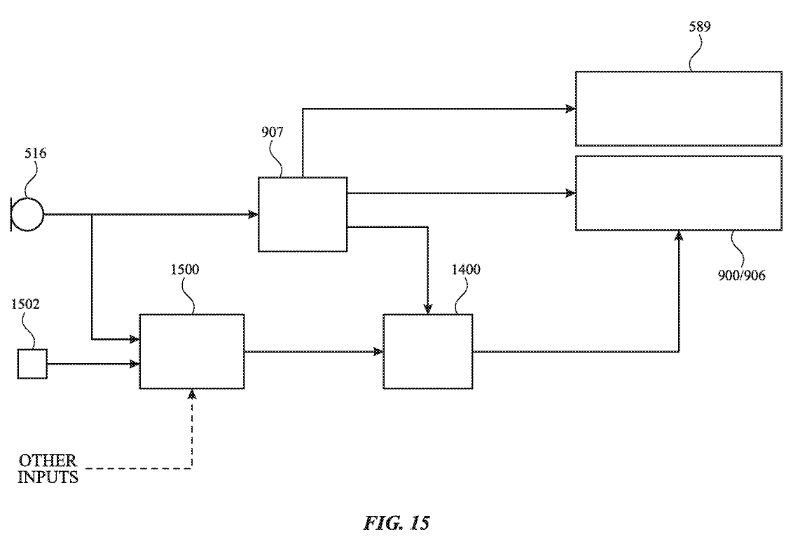

In one or more other implementations, the audio device 150 may automatically turn on or off the ELEQ 1400 in certain acoustic environments, operating modes, and/or based on user preferences (e.g., user preferences input by the user, or user preferences learned using a machine learning model at the electronic device that has been trained to determine a user preference based on inputs from one or more microphones and/or other sensors at the electronic device, based on calendar information, based on purchase information, or the like). For example, FIG. 15 illustrates an example in which the architecture of the audio device 150 includes a decision block 1500 that can be used to turn on or off the ELEQ 1400 in one or more implementations.

The decision block 1500 may be implemented, for example, as a digital signal processor (DSP) or a trained machine learning model in various implementations. In the example of FIG. 15, the decision block 1500 receives inputs from environmental sensors such as the microphone(s) 516 and an accelerometer 1502. In this example, the decision block 1500 may determine a type of acoustic environment (e.g., a social setting such as a party, a bar, or a restaurant, or another acoustic environment such as a performance, a concert, a play, a movie, an opera, a musical, an office, a home, a vehicle, etc.) in which the audio device is disposed, and/or a type of activity the user 101 of the audio device 150 is engaged in. As shown, the decision block 1500 may receive one or more other inputs in one or more implementations. As examples, the other inputs may include calendar information (e.g., calendar information indicating that the user 101 of the audio device 150 may be in a meeting at work, working out at the gym, at a party, or at a performance such as a concert or the like), purchase information (e.g., purchase information indicating a purchase of a ticket to performance, such as a movie, a show, or a concert), activity information (e.g., indicating that the user is stationary, walking, running, or dancing), or the like. The other inputs may also include operational state information, voice activity detection (VAD) signals, or the like. For example, the other inputs may include one or more triggers for modifications for a translation session (e.g., for a live conversation or for a performance), and/or one or more indicators (e.g., from a translator application at the audio device 150 or the electronic device 104) that a translation session 420 is active, that translated audio is being output by the speaker 512 or is to be output by the speaker 512 at a particular time, and/or that a user’s own voice is active.

As shown, the ELEQ 1400, the gain stage 589, the pass-through filter 900, and/or the gain stage 906 may receive the mixing value, and/or a gain (e.g., A, or 1-A) derived therefrom, from the adaptive controller 907 in one or more implementations. The ELEQ 1400 may determine a gain curve based on the mixing value (e.g., or the gain) and/or based on an output from the decision block 1500 (e.g., an output generated based on an indication that translated audio is being output by the speaker 512 or is to be output by the speaker 512 at a particular time, and/or that a user’s own voice is active), and provide that gain curve to the ANC filter 587, the gain stage 589, the gain stage 906, and/or the pass-through filter 900. In one or more implementations, the output from the decision block 1500 may include an instruction to activate (e.g., turn on, such as when the decision block 1500 determines that the user is at a concert or a party and/or that translated audio is being output) or deactivate (e.g., turn off, such as when the decision block 1500 determines that the user is working in an office and/or that the user’s own voice is active) the ELEQ 1400. In one or more implementations, the output from the decision block 1500 may include an instruction for the ELEQ 1400 to modify to a gain curve based on the acoustic environment and/or activity the user is engaged in. For example, in music or concert acoustic environments detected by the decision block 1500, the gain curve to applied by the gain stage 906 and/or the pass-through filter 900 can be tuned stronger (e.g., with higher bass and treble gains). As another example, in acoustic environments determined by the decision block 1500 to have large amounts of undesirable noise (e.g., traffic noise, airplane noise, fan noise, HVAC noise, people noise, appliance noise, or the like), the gain curve to applied by the gain stage 906 and/or the pass-through filter 900 can be tuned weaker to prioritize reducing the noise level. As another example, when translated audio (e.g., for a live conversation) is being output by the speaker 512, a gain curve that effectively low pass filters the ambient noise may be selected (e.g., based also on the amount of the noise cancellation that is being performed, as discussed herein in connection with FIG. 7). As another example, when translated audio for a performance is being output by the speaker 512, a gain curve that passes through background sounds of the performance may be selected. In this way, the decision block 1500 may classify the acoustic environment and/or operational state of the audio device 150 and/or the electronic device 104 and help further fine tune the ELEQ 1400 and/or the gain curves provided thereby based on the classification.

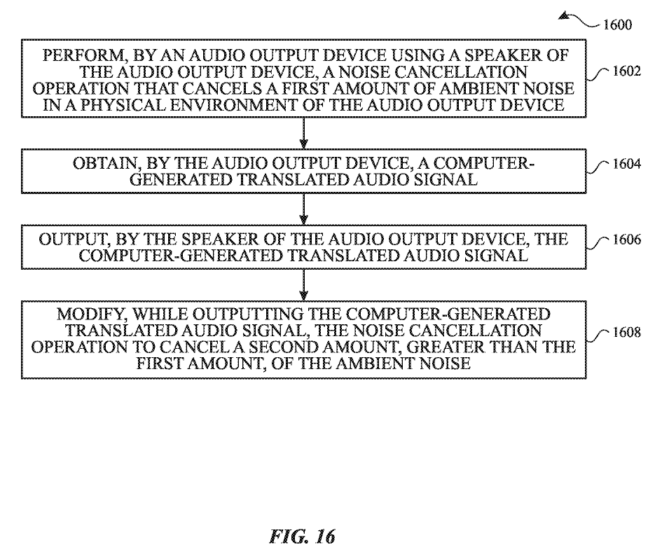

FIG. 16 is a flow chart of an example process 1600 that may be performed for adaptive noise cancellation for real-time audio translations by electronic devices in accordance with implementations of the subject technology. For explanatory purposes, the process 1600 is primarily described herein with reference to the audio device 150 described in connection with FIGS. 1-15. However, the process 1600 is not limited to the audio device 150 described in connection with FIGS. 1-15, and one or more blocks (or operations) of the process 1600 may be performed by one or more other components of other suitable devices, including the electronic device 110, the electronic device 115, and/or the servers 120. Further for explanatory purposes, some of the blocks of the process 1600 are described herein as occurring in series, or linearly. However, multiple blocks of the process 1600 may occur in parallel. In addition, the blocks of the process 1600 need not be performed in the order shown and/or one or more blocks of the process 1600 need not be performed and/or can be replaced by other operations.

As illustrated in FIG. 16, at block 1602, an audio output device (e.g., audio device 150) may perform, using a speaker (e.g., a speaker 512, such as a speaker 152) of the audio output device, a noise cancellation operation that cancels a first amount of ambient noise in a physical environment of the audio output device. For example, performing the noise cancellation operation may include outputting a noise cancellation signal (e.g., noise cancellation signal 511). As another example, performing the noise cancellation operation may include mixing a noise cancellation signal and a pass-through audio signal according to a mixing value (e.g., MV) that is based on an ambient sound level in the physical environment.

At block 1604, the audio output device may obtain a computer-generated translated audio signal. In one or more implementations, obtaining the computer-generated translated audio signal may include receiving the computer-generated translated audio signal from a companion device (e.g., electronic device 104). In one or more other implementations, obtaining the computer-generated translated audio signal may include generating the computer-generated translated audio signal at the audio output device responsive to receiving, with one or more microphones of the audio output device, a voice (e.g., voice 222) of a person (e.g., person 201) speaking in a language other than language that is understood by a user (e.g., user 101) of the audio output device. For example, the person speaking may be speaking to the user in a talk or a speech, or in a live conversation (e.g., speaking without background sounds that are intended to accompany the person’s speech).

At block 1606, the speaker of the audio output device may output the computer-generated translated audio signal. For example, the computer-generated translated audio signal may be provided to the speaker of the audio output device to cause the speaker to generate sound that includes a computer-generated voice speaking a translated version of speech by a person in the physical environment of the audio output device.

At block 1608, the audio output device may modify, while outputting the computer-generated translated audio signal (e.g., between times T3 and T5 or after time T8 in the example of FIG. 4), the noise cancellation operation to cancel a second amount, greater (e.g., by an amount, DA, as shown in FIG. 4) than the first amount, of the ambient noise. After outputting the computer-generated translated audio signal, the audio output device may return to performing the noise cancellation operation that cancels the first amount of the ambient noise. In one or more implementations, after outputting the computer-generated translated audio signal and during speech (e.g., by voice 224) by a user (e.g., user 101) of the audio output device, the audio output device further modify the noise cancellation operation cancel a third amount, different from (e.g., less than or more than) the first amount, of the ambient noise (e.g., as indicated by the dashed line between times T5 and T7 of FIG. 4, and/or the offset, Δ2 of FIG. 11).

In one or more implementations, modifying the noise cancellation operation may include applying a frequency-dependent modification (e.g., according to a frequency-dependent attenuation curve, such as one of attenuation curves 706A, 706B, etc. of FIG. 7) to the noise cancellation operation. For example, applying the frequency-dependent modification to the noise cancellation operation may include applying frequency-dependent gain (e.g., a gain curve 606 or a gain curve 1206) to a noise cancellation signal generated by the noise cancellation operation (e.g., by noise cancellation filter 587) to effectively low pass filter the ambient noise. For example, low pass filtering the ambient noise may generate a blurring effect on the ambient noise for a user of the audio output device. Low pass filtering the ambient noise may also help to reduce pressure variations in the user’s ear canal when the amount of noise cancellation is varied.

In one or more implementations (e.g., in which performing the noise cancellation operation includes mixing a noise cancellation signal and a pass-through audio signal according to a mixing value), modifying the noise cancellation operation may include modifying the mixing value. For example, the mixing value may be obtained from a mixing curve corresponding to an operational mode (e.g., an operational state 807) of a companion device (e.g., electronic device 110) of the audio output device, and modifying the mixing value may include obtaining an updated mixing value that is offset (e.g., by an amount, Δ1) from the mixing curve. In one or more implementations, modifying the noise cancellation operation may include modifying at least one of: a first gain (e.g., 1-A) that is applied to the noise cancellation signal or a second gain (e.g., A) that is applied to the pass-through audio signal. In one or more implementations, modifying the noise cancellation operation may include modifying one or more coefficients of an active noise cancellation (ANC) filter (e.g., ANC filter 587) or a pass-through filter (e.g., pass-through filter 900).

In one or more implementations, the process 1600 may also include receiving a trigger signal from a companion device (e.g., electronic device 104) of the audio output device to initiate modifying the noise cancellation operation. For example, the trigger signal may include an indication of a time (e.g., time T3 or time T8 in FIG. 4) at which output of the computer-generated translated audio signal by the speaker is to begin.

In accordance with one or more implementations, an audio output device (e.g., audio device 150) is provided that includes a speaker (e.g., a speaker 512, such a speaker 152), and processing circuitry (e.g., processing circuitry 202). The processing circuitry may be configured to: perform, using the speaker, a noise cancellation operation that cancels a first amount of ambient noise in a physical environment of the audio output device; obtain a computer-generated translated audio signal; output, by the speaker, the computer-generated translated audio signal; and modify, while outputting the computer-generated translated audio signal, the noise cancellation operation to cancel a second amount, greater than the first amount, of the ambient noise. In one or more implementations, the audio output device may include an earbud. The processing circuitry may be configured to obtain the computer-generated translated audio signal by receiving the computer-generated translated audio signal from a companion device (e.g., electronic device 104) over a wireless connection with the companion device. The processing circuitry may be configured to receive an indication from the companion device to modify the noise cancellation operation while outputting the computer-generated translated audio signal. The processing circuitry may be configured to modify the noise cancellation operation by modifying a gain that is applied (e.g., by a gain stage 589) to a noise cancellation signal or (e.g., by a gain stage 906) to a pass-through audio signal. The processing circuitry may be configured to modify the noise cancellation operation by modifying one or more coefficients of a noise cancellation filter (e.g., ANC filter 587) or a pass-through filter (e.g., pass-through filter 900) at the audio output device.

In accordance with one or more implementations, processing circuitry (e.g., processing circuitry 202) is provided that is configured to: control a speaker (e.g., a speaker 512, such a speaker 152) of an audio output device (e.g., audio device 150) to cancel a first amount of ambient sound in a physical environment of the audio output device; obtain a computer-generated translated audio signal; control the speaker to output the computer-generated translated audio signal; and modify, while outputting the computer-generated translated audio signal, the control of the speaker to cancel a second amount, greater than the first amount, of the ambient sound.

Various examples are described herein in which, during a translation session, ambient noise suppression is increased (e.g., in a flat or frequency-dependent manner) during times when a computer-generated translated audio signal is being output by a speaker, which may increase a user’s ability to hear and understand the computer-generated translated voice. However, in one or more use cases (e.g., use cases in which the original, untranslated, voice of the person to be translated includes one or more frequencies that are not sufficiently suppressed by the increased noise suppression), increasing the ambient noise suppression in this way may result in an undesirable amount of the original voice of the person (that is currently being translated) being passed through to the user’s ears at the same time that the computer-generated translated version of that voice is being output by the speaker. In yet other use cases, the translation session may be a performance translation session for translating a voice of a performer in a performance (e.g., a movie being shown at a theater or on a television, or a live performance, such as a play, an opera, a musical, or a concert) that includes the voice in addition to background sounds, such as music or other background sounds that form part of the soundtrack for the performance. In these performance translation sessions, it may be desirable to avoid removing the background sounds while outputting the computer-translated voice of the performer. For example, for a user attending an opera, it may be undesirable to have the music of the opera suppressed while a translation of a singer in the opera is generated. For example, it may be preferable to provide the full sounds of the performance to the user, with only the voice of the speaking/singing performer modified by translation.

In one or more implementations, in order, for example, to avoid or reduce an undesirable amount of the original voice of the person (e.g., the target voice for translation) being passed through to the user’s ears at the same time that the computer-generated translated version of that voice is being output by the speaker of a device, the original voice of the person may be removed (e.g., using a source separator) from a pass-through audio signal before the pass-through audio signal is combined (e.g., by adder 910) with a noise cancellation signal (e.g., according to a mixing value and/or a gain curve as discussed herein) and a translated audio signal for output by a speaker. In some implementations, a reduced or blurred version of the original voice can also be separately recombined with the voice-removed pass-through audio signal, the noise cancellation signal, and the translated audio signal, as discussed in further detail hereinafter. For example, in one or more implementations, the process 1600 of FIG. 16 may also include removing an untranslated voice (e.g., the target voice) corresponding to the computer-generated translated audio signal from the ambient noise, and outputting, by the speaker of the audio output device and while outputting the computer-generated translated audio signal and modifying the noise cancellation operation, a blurred version of the untranslated voice. The process 1600 of FIG. 16 may also include outputting, by the speaker and during a translation session that includes the outputting of the computer-generated translated audio signal, an own voice signal of a user of the audio output device.

In one or more implementations, in order, for example, to avoid undesirably suppressing or removing background sounds from a performance while generating a translation of a voice of a performer in that performance, the background sounds of the performance (e.g., without the voice of the performer that is being translated) can passed through to the speaker (e.g., without attenuation or suppression, such as using a mixing value of 0, which may correspond to a gain, A = 1 in the examples described herein) while the computer-generated translated voice of the performer is being output by the speaker of the device. In some implementations, a reduced or blurred version of the original voice of the performer being translated can also be separately recombined with the voice-removed pass-through audio signal and the translated audio signal.

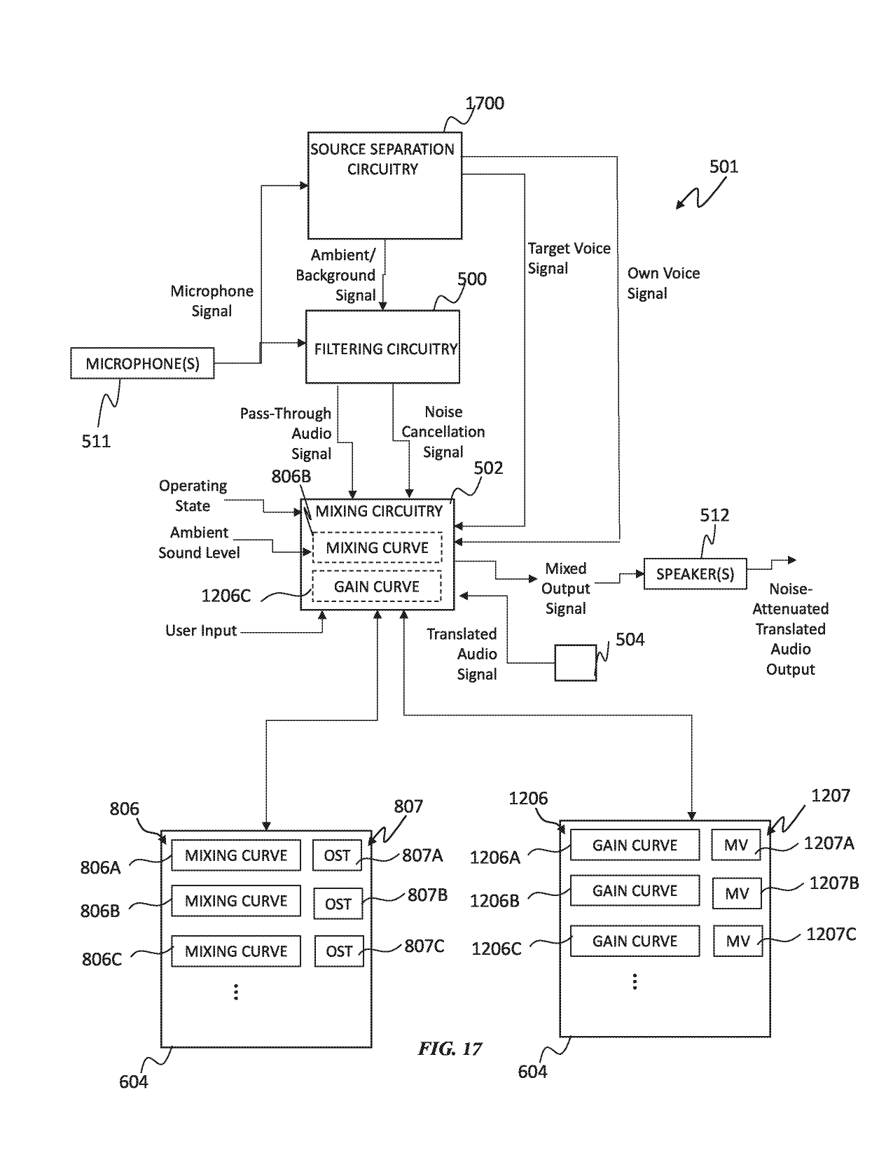

For example, FIG. 17 illustrates an implementation in which the architecture 501 includes additional features for avoiding or reducing an undesirable amount of the original voice of the person being translated being passed through to the user’s ears at the same time that the computer-generated translated voice is being output by the speaker of a device, and/or for avoiding undesirably suppressing or removing background sounds from a performance while generating a translation of a voice of a performer in that performance.

As shown in FIG. 17, the architecture 501 may include source separation circuitry 1700 that receives one or more microphone signals from one or more microphones, such as microphone 516. The source separation circuitry 1700 may include an OVAD for detecting a user’s own voice in the microphone signals and/or a TVAD for detecting a target voice (e.g., voice 222 of person 201) to be translated in the microphone signals. The source separation circuitry 1700 may include one or more digital signal processors and/or trained machine learning models that receive the microphone signal(s) and output one or more separated audio streams, such as a target voice signal (e.g., containing substantially only the portion of the microphone signals that include the target person’s voice), an own voice signal (e.g., containing substantially only the portion of the microphone signals that include the user’s own voice), and an ambient/background signal (e.g., containing substantially only the portion of the microphone signals that includes ambient sounds or background sounds without including the target voice or the user’s own voice).

As shown, the target voice signal, the own voice signal, and/or the ambient/background signal may be provided from the source separation circuitry 1700 to the filtering circuitry 500 and/or the mixing circuitry 502. In another example, rather than providing the target voice signal, the own voice signal, and/or the ambient/background signal from the source separation circuitry 1700 to the filtering circuitry 500 and/or the mixing circuitry 502, the source separation circuitry 1700 may provide information (e.g., mask information, such as a target voice mask and an own voice mask) that identifies the portions of the microphone signals corresponding to the target voice, the user’s own voice, and/or the ambient/background sounds, to allow the target voice signal, the own voice signal, and/or the ambient/background signal to be generated by the filtering circuitry 500 (e.g., and provided to the mixing circuitry 502 from the filtering circuitry 500).

In one or more implementations, in order, for example, to avoid or reduce an undesirable amount of the target voice being passed through in the noise-attenuated translated audio output, the pass-through audio signal may be generated based on the ambient/background signal (e.g., without the target voice therein). In some implementations, the mixing circuitry 502 may then mix a reduced or blurred version of the target voice signal back into the mixed output signal with the (e.g., target-voice-removed) ambient/background pass-through signal, so that the target voice in the original language remains present in a way that reduces the effect on the user’s ability to hear or understand the translated version of the voice in the noise-attenuated translated audio output. In some implementations, the mixing circuitry 502 may also mix the own voice signal (e.g., with an enhanced version of the user’s own voice) into the mixed output signal to allow the user to hear their own voice clearly when they speak during a translation session.

In one or more implementations, in order, for example, to avoid undesirably suppressing or removing background sounds from a performance while generating a translation of a voice of a performer in that performance, during a translation session for a performance (e.g., as identified in the operating state provided to the mixing circuitry), the mixing circuitry may include the (e.g., target-voice-removed) ambient/background signal as the pass-through signal unattenuated (e.g., by selecting the gain curve 1206A, which may be a flat gain curve, for a mixing value 1207A equal to zero) or with a small attenuation. In these implementations, the mixing circuitry 502 may then mix a reduced or blurred version of the target voice signal into the mixed output signal with the unattenuated (e.g., target-voice-removed) ambient/background pass-through signal, so that the voice of the performer remains present in the original language in a way that does not affect the user’s ability to hear or understand the translated version of the voice in the noise-attenuated translated audio output.

Although the source separator(s) 1700 are depicted as being separate from the filtering circuitry 500 in FIG. 17, it is appreciated that the source separator(s) 1700 may be implemented as part of the filtering circuitry 500 and/or as part of the mixing circuitry 502 in various implementations.

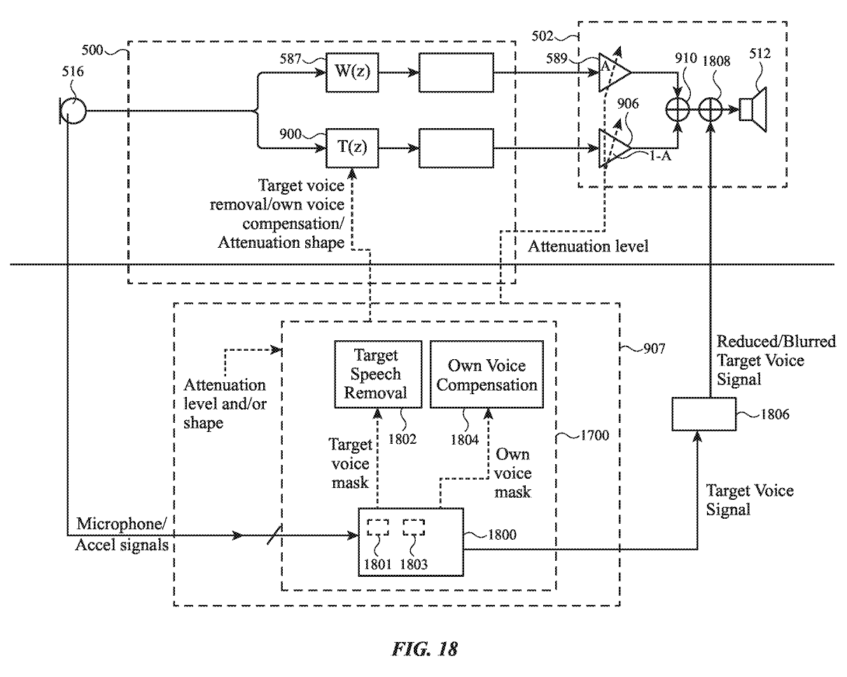

FIG. 18 illustrates additional details that may be included in the architecture of FIG. 17. For example, as shown in FIG. 18, the source separator(s) 1700 may include a source separation block 1800 that may include one or more voice activity detectors (e.g., an OVAD 1801 and a TVAD 1803, as discussed herein), a target speech removal block 1802, and/or an own voice compensation block 1804. As shown, the source separation block 1800, may receive the microphone signals from the microphone(s) 516 and provide information to the target speech removal block 1802 and own voice compensation block 1804. For example, the information may include a target voice mask (e.g., indicating portions of the microphone signals that include the target voice) to the target speech removal block 1802 and an own voice mask (e.g., indicating portions of the microphone signals that contain the user’s own voice) to the own voice compensation block 1804. As shown, the source separation block 1800 may also generate the target voice signal (e.g., by separating the target voice signal from the microphone signals using a DSP or trained machine learning model).

In this example, based on the outputs of the target speech removal block 1802 and the own voice compensation block 1804, the adaptive control circuitry 907 provides control signals to the pass-through filter 900, the gain stage 589, and the gain stage 906. For example, during a translation session for a conversation or other use case in which the ambient or background sounds are not associated with the target speech, the control signals may cause the filter circuitry 500 and the mixing circuitry 502 to suppress the ambient noise as described in connection with FIGS. 7, 12 and 16. The target speech signal may then be modified by processing block 1806 (e.g., to reduce or blur the target speech signal), and the reduced/blurred target speech signal may then be mixed with the output of the adder 910 (e.g., by another adder 1808) to generate the mixed output signal (e.g., also including the translated audio signal) to be provided to the speaker 512.

As another example, during a translation session for a performance, or another use case in which the ambient or background sounds are associated with (e.g., intended to accompany) the target speech (e.g., of a performer in the performance), the control signals may cause the filter circuitry 500 and the mixing circuitry 502 to pass through the ambient sounds without attenuation or with minimal attenuation. The target speech signal may then be modified by processing block 1806 (e.g., to reduce or blur the target speech signal), and the reduced/blurred target speech signal may then be mixed with the output of the adder 910 (e.g., by the adder 1808) to generate the mixed output signal (e.g., also including the translated audio signal) to be provided to the speaker 512.

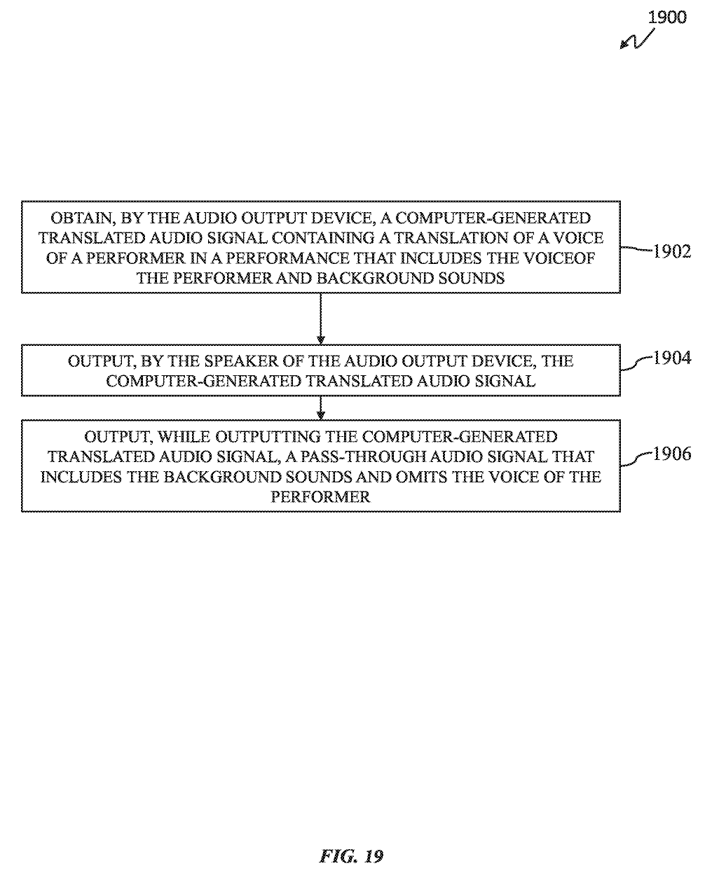

FIG. 19 is a flow chart of an example process 1900 that may be performed for adaptive noise cancellation for real-time audio translations by electronic devices in accordance with implementations of the subject technology. For explanatory purposes, the process 1900 is primarily described herein with reference to the audio device 150 described in connection with FIGS. 1-15, 17 and 18. However, the process 1900 is not limited to the audio device 150 described in connection with FIGS. 1-15, 17 and 18, and one or more blocks (or operations) of the process 1600 may be performed by one or more other components of other suitable devices, including the electronic device 110, the electronic device 115, and/or the servers 120. Further for explanatory purposes, some of the blocks of the process 1900 are described herein as occurring in series, or linearly. However, multiple blocks of the process 1900 may occur in parallel. In addition, the blocks of the process 1900 need not be performed in the order shown and/or one or more blocks of the process 1900 need not be performed and/or can be replaced by other operations.

As illustrated in FIG. 19 at block 1902, an audio output device (e.g., audio device 150) may obtain (e.g., from a translated audio source 504) a computer-generated translated audio signal containing a computer-generated translation of a voice (e.g., voice 222) of a performer (e.g., person 201) in a performance (e.g., a recorded performance being displayed in the physical environment of the audio output device, such as a movie displayed on a movie screen or a television, or a live performance, such as an opera, a musical, a play, or a concert). The performance may include the voice of the performer and background sounds. As examples, the background sounds may include one or more other voices of one or more other performances in the performance and/or music or effects sounds that are part of the soundtrack of the performance. In one or more implementations, the background sounds may include background music and another voice of another performer.

In one or more implementations, obtaining the computer-generated translated audio signal may include receiving the computer-generated translated audio signal from a companion device (e.g., electronic device 104). For example, obtaining the computer-generated translated audio signal may include providing one or more microphone signals from one or more microphones (e.g., microphone 516) of the audio output device to a companion device; and receiving the computer-generated translated audio signal from the companion device. In one or more other implementations, obtaining the computer-generated translated audio signal may include generating the computer-generated translated audio signal at the audio output device responsive to receiving, with one or more microphones of the audio output device, the voice (e.g., voice 222) of the performer (e.g., person 201) speaking and/or singing in a language other than language that is understood by a user (e.g., user 101) of the audio output device.

At block 1904, the computer-generated translated audio signal may be output by a speaker (e.g., speaker(s) 512) of the audio output device. For example, the computer-generated translated audio signal may be provided to the speaker of the audio output device to cause the speaker to generate sound that includes a computer-generated voice speaking (e.g., or singing) a translated version of speech (e.g., spoken or sung) by the performer.

At block 1906, while outputting the computer-generated translated audio signal, a pass-through audio signal that includes the background sounds and omits the voice of the performer may also be output by the speaker of the audio output device. For example, one or more source separators (e.g., source separator(s) 1800) may be used to separate the background sounds, the voice of the performer, and/or a voice of a user/wearer of the audio output device that are included in microphone signals (e.g., obtained using a microphone, such as microphone 516, of the audio output device and/or a companion device) into distinct background, target voice, and own voice signals.

In one or more implementations, the process 1900 may also include outputting, by the speaker of the audio output device and while outputting the computer-generated translated audio signal and the pass-through audio signal, a modified version of the voice of the performer. For example, the modified version of the voice of the performer may include a reduced version or a blurred version of the voice of the performer. For example, blurring the voice of the performer may include reducing the amplitude of the voice only at selected frequencies (e.g., increasingly more at higher and higher frequencies) to cause a blurring or muffling effect to be perceived by the user. Reducing the voice of the performer may include reducing the amplitude at all frequencies.

Aspects of the subject technology discussed herein, when implemented by one or more electronic devices, such as a smartphone and one or more audio devices, can provide improvements to other technologies (e.g., electronic translations and/or ANC) and to functioning of the computing devices on which those other technologies are implemented.

As described above, one aspect of the present technology is the gathering and use of data available from specific and legitimate sources for performing adaptive noise cancellation for real-time translations. The present disclosure contemplates that in some instances, this gathered data may include personal information data that uniquely identifies or can be used to identify a specific person. Such personal information data can include voice samples, voice profiles, demographic data, location-based data, online identifiers, telephone numbers, email addresses, home addresses, biometric data or records relating to a user’s health or level of fitness (e.g., vital signs measurements, medication information, exercise information, motion information, breathing information, heart rate information), date of birth, or any other personal information.

The present disclosure recognizes that the use of such personal information data, in the present technology, can be used to the benefit of users. For example, the personal information data can be used for performing adaptive noise cancellation for real-time audio translations by electronic devices.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of performing adaptive noise cancellation for real-time audio translations by electronic devices, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 20 illustrates an electronic system 2000 with which one or more implementations of the subject technology may be implemented. The electronic system 2000 can be, and/or can be a part of, the audio device 150, the electronic device 104, the electronic device 110, the electronic device 115, and/or the server 120 as shown in FIG. 1. The electronic system 2000 may include various types of computer readable media and interfaces for various other types of computer readable media. The electronic system 2000 includes a bus 2008, one or more processing unit(s) 2012, a system memory 2004 (and/or buffer), a ROM 2010, a permanent storage device 2002, an input device interface 2014, an output device interface 2006, and one or more network interfaces 2016, or subsets and variations thereof.

The bus 2008 collectively represents all system, peripheral, and chipset buses that communicatively connect the numerous internal devices of the electronic system 2000. In one or more implementations, the bus 2008 communicatively connects the one or more processing unit(s) 2012 with the ROM 2010, the system memory 2004, and the permanent storage device 2002. From these various memory units, the one or more processing unit(s) 2012 retrieves instructions to execute and data to process in order to execute the processes of the subject disclosure. The one or more processing unit(s) 2012 can be a single processor or a multi-core processor in different implementations.

The ROM 2010 stores static data and instructions that are needed by the one or more processing unit(s) 2012 and other modules of the electronic system 2000. The permanent storage device 2002, on the other hand, may be a read-and-write memory device. The permanent storage device 2002 may be a non-volatile memory unit that stores instructions and data even when the electronic system 2000 is off. In one or more implementations, a mass-storage device (such as a magnetic or optical disk and its corresponding disk drive) may be used as the permanent storage device 2002.

In one or more implementations, a removable storage device (such as a floppy disk, flash drive, and its corresponding disk drive) may be used as the permanent storage device 2002. Like the permanent storage device 2002, the system memory 2004 may be a read-and-write memory device. However, unlike the permanent storage device 2002, the system memory 2004 may be a volatile read-and-write memory, such as random access memory. The system memory 2004 may store any of the instructions and data that one or more processing unit(s) 2012 may need at runtime. In one or more implementations, the processes of the subject disclosure are stored in the system memory 2004, the permanent storage device 2002, and/or the ROM 2010 (which are each implemented as a non-transitory computer-readable medium). From these various memory units, the one or more processing unit(s) 2012 retrieves instructions to execute and data to process in order to execute the processes of one or more implementations.

The bus 2008 also connects to the input and output device interfaces 2014 and 2006. The input device interface 2014 enables a user to communicate information and select commands to the electronic system 2000. Input devices that may be used with the input device interface 2014 may include, for example, alphanumeric keyboards and pointing devices (also called “cursor control devices”). The output device interface 2006 may enable, for example, the display of images generated by electronic system 2000. Output devices that may be used with the output device interface 2006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 20, the bus 2008 also couples the electronic system 2000 to one or more networks and/or to one or more network nodes, such as the electronic device 110 shown in FIG. 1, through the one or more network interface(s) 2016. In this manner, the electronic system 2000 can be a part of a network of computers (such as a LAN, a wide area network (“WAN”), or an Intranet, or a network of networks, such as the Internet. Any or all components of the electronic system 2000 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user’s client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A method, comprising:
obtaining, by an audio output device, a computer-generated translated audio signal containing a computer-generated translation of a voice of a performer in a performance, wherein the performance includes the voice of the performer and background sounds;
outputting, by a speaker of the audio output device, the computer-generated translated audio signal; and
outputting, by the speaker of the audio output device while outputting the computer-generated translated audio signal, a pass-through audio signal that includes the background sounds and omits the voice of the performer.

2. The method of claim 1, further comprising, outputting, while outputting the computer-generated translated audio signal and the pass-through audio signal, a modified version of the voice of the performer.

3. The method of claim 2, wherein the modified version of the voice of the performer comprises a blurred version of the voice of the performer.

4. The method of claim 1, wherein the background sounds comprise background music and another voice of another performer.

5. The method of claim 1, wherein the performance includes a live performance.

6. The method of claim 1, wherein the performance comprises a movie.

7. The method of claim 1, wherein obtaining the computer-generated translated audio signal comprises:
providing one or more microphone signals from one or more microphones of the audio output device to a companion device; and
receiving the computer-generated translated audio signal from the companion device.

8. An audio output device, comprising:
a speaker; and
processing circuitry configured to:
obtain a computer-generated translated audio signal containing a computer-generated translation of a voice of a performer in a performance, wherein the performance includes the voice of the performer and background sounds;
output, using the speaker, the computer-generated translated audio signal; and
output, using the speaker while outputting the computer-generated translated audio signal, a pass-through audio signal that includes the background sounds and omits the voice of the performer.

9. The audio output device of claim 8, wherein the processing circuitry is further configured to output, while outputting the computer-generated translated audio signal and the pass-through audio signal, a modified version of the voice of the performer.

10. The audio output device of claim 9, wherein the modified version of the voice of the performer comprises a blurred version of the voice of the performer.

11. The audio output device of claim 8, wherein the background sounds comprise background music and another voice of another performer.

12. The audio output device of claim 8, wherein the performance includes a live performance.

13. The audio output device of claim 8, wherein the performance comprises a movie.

14. The audio output device of claim 8, wherein the processing circuitry is configured to obtain the computer-generated translated audio signal by:
providing one or more microphone signals from one or more microphones of the audio output device to a companion device; and
receiving the computer-generated translated audio signal from the companion device.

15. Processing circuitry configured to:
obtain a computer-generated translated audio signal containing a computer-generated translation of a voice of a performer in a performance, wherein the performance includes the voice of the performer and background sounds;
provide, for output by a speaker of a device, the computer-generated translated audio signal; and
generate, for output by the speaker of the device during output of the computer-generated translated audio signal, a pass-through audio signal that includes the background sounds and omits the voice of the performer.

16. The processing circuitry of claim 15, wherein the processing circuitry is further configured to output, while outputting the computer-generated translated audio signal and the pass-through audio signal, a modified version of the voice of the performer.

17. The processing circuitry of claim 16, wherein the modified version of the voice of the performer comprises a blurred version of the voice of the performer.

18. The processing circuitry of claim 15, wherein the background sounds comprise background music and another voice of another performer.

19. The processing circuitry of claim 15, wherein the performance includes a live performance.

20. The processing circuitry of claim 15, wherein the processing circuitry is configured to obtain the computer-generated translated audio signal by:
providing one or more microphone signals from one or more microphones of the device to a companion device; and
receiving the computer-generated translated audio signal from the companion device.
